(19) United States
(12) Patent Application Publication
(10) Pub. No.: US 2024/0297711 A1
(43) Pub. Date: Sep. 5, 2024

(54) System and Method of Optical Fiber Characterization Via Communication Over Multiple Intelligent Panels

(71) Applicant: GolFoton Holdings, Inc., Somerset, NJ (US)

(72) Inventors: Kenichiro Takeuchi, North Brunswick, NJ (US); David Zhi Chen, Dallas, TX (US); Chi Kong Paul Ng, Princeton, NJ (US); Feng Tian, Salem, NH (US); Edward M. Jack, Ashby, MA (US)

(73) Assignee: GolFoton Holdings, Inc., Somerset, NJ (US)

(21) Appl. No.: 18/594,774

(22) Filed: Mar. 4, 2024

Related U.S. Application Data
(60) Provisional application No. 63/535,216, filed on Aug. 29, 2023.
(60) Provisional application No. 63/489,122, filed on Mar. 8, 2023.
(60) Provisional application No. 63/488,403, filed on Mar. 3, 2023.

(51) Int. Cl. H04B 10/071; H04B 10/2537; H04L 7/00

(52) U.S. Cl. CPC H04B 10/071; H04B 10/2537; H04L 7/0075

(57) ABSTRACT

A characterization system includes an optical fiber apparatus, first and second clocks, an optical transmission device at an apparatus first end, first and second optical receiving devices, and a control unit. The transmission device communicates with the first clock and emits optical pulses along the apparatus. The first receiving device communicates with the first clock and receives backscattered or reflected pulse remaining portions. The second receiving device, at an apparatus second end, communicates with the second clock and receives pulse portions. The apparatus has a length such that the first receiving device does not receive pulse remaining portions backscattered or reflected by the second end. The clocks are synchronized or offset by known values such that the control unit determines a characteristic of the apparatus or of the pulses based on, or using optical data derived from the pulses and associated with, pulse emission and corresponding pulse portion receipt times.

### CROSS-REFERENCE TO RELATED APPLICATIONS

The present application claims priority from U.S. Provisional Patent Application No. 63/488,403 filed on Mar. 3, 2023, U.S. Provisional Patent Application No. 63/489,122, filed on Mar. 8, 2023, and U.S. Provisional Patent Application No. 63/535,216, filed on Aug. 29, 2023, the disclosures of all of which are hereby incorporated herein by reference in their entireties.

### BACKGROUND

When opposing optical fibers are optically connected, such optical fibers convey light and thereby optical signals from one of the fibers to the opposing fiber. Such optical connections may occur in the operation of data storage and transmission devices. To establish connections between respective opposing optical fibers, connectors on ends of respective opposing optical fibers are inserted into ports on opposing ends of adapters. These optical assemblies of optical fibers, connectors, and adapters are often part of termination units or assemblies that include patch panels, such as those described in U.S. Patent Application Publication No. 2022/0120989 A1, the entirety of the disclosure of which is hereby incorporated herein by reference.

Sometimes, incomplete connections are made between a connector and an adapter, which may be undetected by users, such as technicians installing or repairing portions of optical fiber termination systems, e.g., patch panels and associated optical fiber cables. Additionally, fatigue or other stresses induced through use of the connectors may weaken mechanical connections between connectors or between a connector and an adapter causing connections to be broken or inadequate. Moreover, damage to the optical fibers themselves can disrupt optical signals or cause such signals to be broken. Such incomplete or broken connections or disrupted signals have caused reduced system performance or even complete system failure. Identification of broken connections or signals can be cumbersome, often requiring time-consuming physical, on-site inspection of multiple optical fiber cables and sometimes even physical inspection of multiple optical fiber termination assemblies.

Systems have been developed to ascertain disruptions in optical signals and power losses within optical fiber systems, such as in U.S. Patent Application Publication No. 2021/0356681 A1, the entirety of the disclosure of which is hereby incorporated herein by reference. As in the example shown in FIG. 1, optical time domain reflectometers (OTDRs) have been used to identify locations along optical fibers causing optical signal disruption. In one example as shown, while 99% (which value may differ in other examples) of light conveyed from the OTDR designated A is received by the OTDR designated B via the optical fiber, damage to the optical fiber, e.g., due to bends or cuts in the fiber, causes the remaining 1% (which value also may differ in other examples) of light conveyed from the OTDR designated A to scatter. Some of the scattered light returns back to the OTDR designated A. Light scattered from position L1 returns to the OTDR designated A at t2, light scattered from position L1′ returns to the OTDR designated A at t2′, and light scattered from position L1″ returns to the OTDR designated A at t2″. In this manner, receipt of light at specific times indicates a possible optical fiber disruption, e.g., one in an optical fiber which causes a reflection and thereby an optical signal disruption, at the location corresponding to half the time it took for the return of the light to the OTDR such that an investigation at that position of the optical fiber should be undertaken. However, the amount of light that returns to the OTDR designated A from positions beyond a maximum length of the optical fiber is insufficient or essentially lacking. As such, the OTDR designated A does not register any returned light and thus does not determine a time of the light's return and thereby a location of an optical signal disruption along the optical fiber beyond the maximum reach of the OTDR.

Therefore, there exists a need for identifying the locations of disruptions of optical signals along relatively longer optical fibers, such as those of lengths greater than the maximum reach of OTDRs.

### SUMMARY

In accordance with an aspect, an optical fiber apparatus characterization system, may include a first optical fiber apparatus, first and second clock devices, a first optical transmission device, first and second optical receiving devices, and a first electronic control unit. The first optical transmission device may be at a first end of the first optical fiber apparatus, may be in electrical or wireless communication with the first clock device, and may be configured to emit first optical pulses along the first optical fiber apparatus. The first optical receiving device may be proximal to the first optical transmission device, may be in electrical or wireless communication with the first clock device, and may be configured to receive first backscattered (e.g., due to Rayleigh backscattering) or reflected optical pulse remaining portions of the first optical pulses emitted by the first optical transmission device. The first backscattered or reflected optical pulse remaining portions may be respectively backscattered or reflected by and along the first optical fiber apparatus towards the first optical receiving device. The second optical receiving device may be at a second end of the first optical fiber apparatus opposite the first end, may be in electrical or wireless communication with the second clock device, and may be configured to receive first optical pulse portions of the first optical pulses emitted along the first optical fiber apparatus. The first electronic control unit may be in communication with the first clock device, the first optical transmission device, the first optical receiving device, the second clock device, and the second optical receiving device. The first optical fiber apparatus may have a sufficient length such that ones of the first backscattered or reflected optical pulse remaining portions backscattered or reflected by the second end of the first optical fiber apparatus may not be received by the first optical receiving device. The first and the second clock devices may be synchronized or have respective times offset by a known offset value such that the first electronic control unit may determine a first characteristic of the first optical fiber apparatus or of the first optical pulses based on, or using optical data derived from the first optical pulses and associated with, a time that one of the first optical pulses is emitted from the first optical transmission device and a time that a corresponding one of the first optical pulse portions is received by the second optical receiving device.

In some arrangements, the first optical fiber apparatus may be a first optical fiber while in other arrangements, the first optical fiber apparatus may include a first optical fiber and other optical componentry, such as connectors, adapters, and the like that form a fiber optic line, which may be a line through which portions of an optical pulse may pass.

In some arrangements in accordance with any of the foregoing, the first optical transmission device and the first optical receiving device may be part of an optical time domain reflectometer or a distributed acoustic sensing unit.

In some arrangements in accordance with any of the foregoing, the first electronic control unit may be in communication either directly or indirectly with the first clock device, the first optical transmission device, the first optical receiving device, the second clock device, and the second optical receiving device. In some arrangements in accordance with any of the foregoing, the first electronic control unit may be configured to either one of or both direct operation of or receive data relating to a status or operation of each of these devices.

In some arrangements in accordance with any of the foregoing, the first electronic control unit may be in communication either directly or indirectly with the first clock device, the first optical transmission device, the first optical receiving device, the second clock device, and the second optical receiving device via electrical, optical, wireless connections. Such communication may be via a cloud network to which the first electronic control unit and any one or any combination of these devices may be connected.

In some arrangements in accordance with any of the foregoing, the first electronic control unit may determine a second characteristic of the first optical fiber apparatus or of the first optical pulses based on, or using optical data derived from the first optical pulses and associated with, a time that one of the first optical pulses is emitted from the first optical transmission device and a time that a corresponding one of the first backscattered or reflected optical pulse remaining portions of the first optical pulses emitted by the first optical transmission device and reflected along the first optical fiber apparatus towards the first optical receiving device is received by the first optical receiving device.

In some arrangements in accordance with any of the foregoing, the optical fiber apparatus characterization system may further include a second optical transmission device. The second optical transmission device may be configured to emit second optical pulses along the first optical fiber apparatus. In some such arrangements, the second optical receiving device may be proximal to the second optical transmission device and may be configured to receive second backscattered or reflected optical pulse remaining portions of the second optical pulses emitted by the second optical transmission device and respectively backscattered or reflected along the first optical fiber apparatus towards the first optical receiving device.

In some arrangements in accordance with any of the foregoing, the second optical transmission device may be part of an optical time domain reflectometer or a distributed acoustic sensing unit. In such arrangements, the first optical transmission device and the first optical receiving device, respectively, may be part of an optical time domain reflectometer or a distributed acoustic sensing unit.

In some arrangements, the first optical receiving device may be configured to receive second optical pulse portions of the second optical pulses emitted along the first optical fiber apparatus. In such arrangements, the first optical fiber apparatus may have a sufficient length such that ones of the second backscattered or reflected optical pulse remaining portions of the second optical pulses backscattered or reflected by the first end of the first optical fiber apparatus may not be not received by the second optical receiving device.

In some arrangements, the first electronic control unit may determine a second characteristic of the first optical fiber apparatus or of the first optical pulses based on, or using optical data derived from the first optical pulses, a time that one of the first optical pulses is emitted from the first optical transmission device and a time that a corresponding one of the first backscattered or reflected optical pulse remaining portions of the first optical pulses emitted by the first optical transmission device along the first optical fiber apparatus is received by the first optical receiving device. In some such arrangements, the first electronic control unit may determine a third characteristic of the first optical fiber apparatus or of the second optical pulses based on, or using optical data derived from the second optical pulses, a time that one of the second optical pulses is emitted from the second optical transmission device and a time that a corresponding one of the second backscattered or reflected optical pulse remaining portions of the second optical pulses emitted by the second optical transmission device along the first optical fiber apparatus is received by the second optical receiving device.

In some arrangements, the first backscattered or reflected optical pulse remaining portions of the first optical pulses received by the first optical receiving device and the second backscattered or reflected optical pulse remaining portions of the second optical pulses received by the second optical receiving device do not travel over a same region of the first optical fiber apparatus. In some such arrangements, the first characteristic determined by the first electronic control unit may correspond to a portion of the first optical fiber apparatus from which neither one of the first backscattered or reflected optical pulse remaining portions of the first optical pulses and the second backscattered or reflected optical pulse remaining portions of the second optical pulses is backscattered or reflected by the first optical fiber apparatus.

In some arrangements, the first backscattered or reflected optical pulse remaining portions of the first optical pulses received by the first optical receiving device and the second backscattered or reflected optical pulse remaining portions of the second optical pulses received by the second optical receiving device travel over a shared region of the first optical fiber apparatus. In some such arrangements, the first characteristic determined by the first electronic control unit may correspond to a portion of the first optical fiber apparatus at which both the first backscattered or reflected optical pulse remaining portions of the first optical pulses and the second backscattered or reflected optical pulse remaining portions of the second optical pulses are backscattered or reflected by the first optical fiber apparatus.

In some arrangements in accordance with any of the foregoing, the first characteristic may be a length of the first optical fiber apparatus. In some such arrangements, the length may be determined in a length determining process by the first electronic control unit based on a product of a time of travel of the corresponding one of the first optical pulse portions received by the second optical receiving device from the first optical transmission device and a preset speed of the first optical pulses. The time of travel may be determined based on a difference between a second clock time of the second clock device at the time the corresponding one of the first optical pulse portions is received by the second optical receiving device and a corresponding first clock time of the first clock device at the time the corresponding one of the first optical pulses is emitted from the first optical transmission device. In some such arrangements, the first optical fiber apparatus may be only a single optical fiber and the preset speed of the first optical pulses may be preset based on known material of the first optical fiber. In some arrangements, the first electronic control unit may periodically or continuously monitor the length of the first optical fiber apparatus using the length determining process.

In some arrangements, the optical fiber apparatus characterization system may further include a second optical fiber apparatus and a second optical transmission device. The second optical transmission device may be at a first end of the second optical fiber apparatus, may be in electrical or wireless communication with the second clock device, and may be configured to emit second optical pulses along the second optical fiber apparatus. In some such arrangements, the second optical receiving device and the second optical transmission device may be part of a second optical termination assembly.

In some arrangements, the optical fiber apparatus characterization system may further include an optical switch. In some such arrangements, the second optical transmission device may be further configured to emit the second optical pulses along the first optical fiber apparatus via the optical switch. In some such arrangements, the second optical receiving device may be configured to receive second backscattered or reflected optical pulse remaining portions of the second optical pulses emitted along the first optical fiber apparatus and to receive second backscattered or reflected optical pulse remaining portions of the second optical pulses emitted along the second optical fiber apparatus. In some such arrangements, the first electronic control unit may determine a second characteristic of the second optical fiber apparatus or of the second optical pulses emitted by the second optical transmission device along the second optical fiber apparatus based on, or using optical data derived from the second optical pulses emitted by the second optical transmission device along the second optical fiber apparatus and associated with, a time that one of the second optical pulses is emitted from the second optical transmission device along the second optical fiber apparatus and a time that a corresponding one of second backscattered or reflected optical pulse remaining portions of the second optical pulses is received by the second optical receiving device.

In some arrangements, the optical fiber characterization system may further include a third optical receiving device that may be proximal to the second optical transmission device, may be in electrical or wireless communication with the second clock device, and may be configured to receive second backscattered or reflected optical pulse remaining portions of the second optical pulses emitted by the second optical transmission device. In such arrangements, the second backscattered or reflected optical pulse remaining portions may be respectively backscattered or reflected by and along the second optical fiber apparatus towards the third optical receiving device. In some such arrangements, the third optical receiving device may be part of the second optical termination assembly.

In some such arrangements, the optical fiber apparatus characterization system may further include a third clock device and a fourth optical receiving device. The fourth optical receiving device may be at a second end of the second optical fiber apparatus opposite the first end, may be in electrical or wireless communication with the third clock device, and may be configured to receive second optical pulse portions of the second optical pulses emitted along the second optical fiber apparatus. In some such arrangements, the first electronic control unit may be in electrical or wireless communication with the second optical transmission device, the third optical receiving device, the third clock device, and the fourth optical receiving device. In some arrangements, the second optical fiber apparatus may have a sufficient length such that ones of the second backscattered or reflected optical pulse remaining portions of the second optical pulses backscattered or reflected by the first end of the second optical fiber apparatus may not be received by the fourth optical receiving device. In some such arrangements, the second and the third clock devices may be synchronized or have respective times offset by a known offset value such that the first electronic control unit may determine a first characteristic of the second optical fiber apparatus or of the second optical pulses based on, or using optical data derived from the second optical pulses and associated with, a time that one of the second optical pulses is emitted from the second optical transmission device and a time that a corresponding one of the second optical pulse portions is received by the fourth optical receiving device. In some such arrangements, the first electronic control unit may determine a second characteristic of the second optical fiber apparatus or of the second optical pulses based on, or using optical data derived from the second optical pulses and associated with, a time that one of the second optical pulses is emitted from the second optical transmission device and a time that a corresponding one of the second backscattered or reflected optical pulse remaining portions of the second optical pulses is received by the third optical receiving device.

In some arrangements, the optical fiber apparatus characterization system may further include an additional optical fiber apparatus and an additional optical transmission device. The additional optical transmission device may be at a first end of the additional optical fiber apparatus and may be configured to emit first additional optical pulses along the additional optical fiber apparatus. In some such arrangements, the first optical transmission device and the first optical receiving device may be part of a first optical termination assembly. In some such arrangements, the additional optical transmission device may be part of a third optical termination assembly. In some such arrangements, at least two optical fibers extend from each of the termination assemblies such that an optical fiber extends between every pair of termination assemblies in the optical fiber apparatus characterization system.

In some arrangements, the optical fiber apparatus characterization system may further include an additional optical receiving device. In some such arrangements, the additional optical receiving device may be in electrical or wireless communication with the first clock device and may be configured to receive additional optical pulse portions of the additional optical pulses. In some arrangements, the additional optical receiving device may be at a second end of the additional optical fiber apparatus opposite the first end of the additional optical fiber apparatus and is part of the first optical termination assembly.

In accordance with another aspect, the optical fiber apparatus characterization system may further include an optical reflecting element. The optical reflecting element may be configured to reflect at least parts of the first optical pulse portions of the first optical pulses along the first optical fiber apparatus such that the reflected parts of the first optical pulse portions are received by the first optical receiving device along the first optical fiber apparatus via the first optical fiber apparatus. In such arrangements, the first and the second clock devices may be asynchronous during a first time period from when the first optical pulse is emitted from the first optical transmission device along the first optical fiber apparatus to when the reflected parts of the first optical pulse portions are received by the first optical receiving device along the first optical fiber apparatus. In such arrangements, the first electronic control unit may instruct a clock adjustment to be made. The clock adjustment may include a first adjustment of a first clock time of the first clock device, a second adjustment of a second clock time of the second clock device, or a combination of adjustments of both the first and the second clock times such that the first and the second clock devices may be synchronized with each other. In some arrangements, the optical reflecting element may be a mirror.

In accordance with another aspect, an optical system may include a first optical fiber apparatus, first and second clock devices, a first optical transmission device, first and second optical receiving devices, an optical reflecting element, and a first electronic control unit. The first optical transmission device may be in electrical or wireless communication with the first clock device and may be configured to emit a first optical pulse along the first optical fiber apparatus. The first optical receiving device may be proximal to the first optical transmission device, may be in electrical or wireless communication with the first clock device, and may be configured to receive a first reflected optical pulse remaining portion of the first optical pulse along the first optical fiber apparatus. The optical reflecting element may be configured to reflect the first reflected optical pulse remaining portion of the first optical pulse along the first optical fiber apparatus such that the first reflected optical pulse remaining portion of the first optical pulse is received by the first optical receiving device via the first optical fiber apparatus. The second optical receiving device may be in electrical or wireless communication with the second clock device and may be configured to receive a first optical pulse portion of the first optical pulse. The first and the second clock devices may be asynchronous during a first time period from when the first optical pulse is emitted from the first optical transmission device to when the first reflected optical pulse remaining portion is received by the first optical receiving device. The first electronic control unit may be in communication with the first clock device, the first optical transmission device, the first optical receiving device, the second clock device, and the second optical receiving device. The first electronic control unit may be configured for instructing a clock adjustment to be made. In such arrangements, the clock adjustment may include a first adjustment of a first clock time of the first clock device, a second adjustment of a second clock time of the second clock device, or a combination of adjustments of both the first and the second clock times such that the first and the second clock devices are synchronized with each other.

In some arrangements, the clock adjustment may be only the second adjustment In some such arrangements, the second adjustment may be a value equal to half of the sum of the first clock time when the first reflected optical pulse remaining portion is received by the first optical receiving device and the first clock time when the first optical pulse is emitted by the first optical transmission device less, i.e., minus, the second clock time when the first optical pulse portion is received by the second optical receiving device.

In some arrangements in accordance with any of the foregoing, the first optical transmission device and the first optical receiving device may be parts of a first transceiver.

In some arrangements in accordance with any of the foregoing, the second optical receiving device may be part of a second transceiver.

In some arrangements in accordance with any of the arrangements of the foregoing aspect, when the first and the second clock devices are synchronized, a length of the first optical fiber is determined, in a length determining process, by the first electronic control unit based on a product of a time of travel of a second optical pulse portion of a second optical pulse from the first optical transmission device to the second optical receiving device and a preset speed of the second optical pulse. In such arrangements, the time of travel of the second optical pulse portion may be determined based on a difference between the second clock time at the time the second optical pulse portion is received by the second optical receiving device and the first clock time at the time the second optical pulse is emitted from the first optical transmission device. In some arrangements, the preset speed of the second optical pulse may be preset based on known material of the first optical fiber.

In some arrangements, the first electronic control unit may periodically or continuously monitor the length of the first optical fiber apparatus using the length determining process.

In some arrangements, the optical system may further include a second electronic control unit that may be in electrical or wireless communication with the second clock device and the second optical receiving device. In some such arrangements, the second optical receiving device may be configured to receive the second optical pulse portion. In some such arrangements, the second electronic control unit may be configured such that when the first and the second clock devices are synchronized, the second electronic control unit may sample both initial optical power level data from the second optical pulse at the time the second optical pulse is emitted from the first optical transmission device and subsequent optical power level data from the second optical pulse portion at the time the second optical pulse portion is received by the second optical receiving device. In such arrangements, in a distortion determining process, the second electronic control unit may determine one or more differences between the initial and the subsequent optical power level data in order to ascertain optical distortion characteristics associated with the first optical fiber.

In some arrangements in accordance with any of the arrangements of the foregoing aspect, the first optical transmission device and the first optical receiving device may be part of an optical time domain reflectometer or a distributed acoustic sensing unit.

In some arrangements in accordance with any of the arrangements of the foregoing aspect, the first electronic control unit may be remote from each of the first clock device, the first optical transmission device, the first optical receiving device, the second clock device, and the second optical receiving device.

In some arrangements, the optical system may further include a second electronic control unit that may be in electrical or wireless communication with the second clock device and the second optical receiving device. In some such arrangements, the first electronic control unit may be proximal to the first transmission device and the second electronic control unit may be proximal to the second optical receiving device. In some such arrangements, the second electronic control unit may be in electrical or wireless communication with the first clock device, the first optical transmission device, and the first optical receiving device via the first electronic control unit.

In some arrangements in accordance with any of the arrangements of the foregoing aspect, the optical reflecting element may be a mirror. In some such arrangements, the mirror may be positioned and otherwise configured relative to the second optical receiving device such that the mirror may separate the first reflected optical pulse remaining portion received by the first optical receiving device from the first optical pulse while allowing the first optical pulse portion to pass by the mirror. In this manner, the first optical pulse portion may be received by the second optical receiving device.

In accordance with another aspect, an optical system may include a first optical fiber apparatus, first and second clock devices, first and second optical transmission devices, first and second optical receiving devices, and a first electronic control unit. The first optical transmission device may be at a first end of the first optical fiber apparatus, may be in electrical or wireless communication with the first clock device, and may be configured to emit a first optical pulse along the first optical fiber apparatus. The second optical transmission device may be at a second end of the first optical fiber apparatus opposite the first end, may be in electrical or wireless communication with the first clock device, and may be configured to emit a second optical pulse along the first optical fiber apparatus. The first optical receiving device may be proximal to the first optical transmission device, may be in electrical or wireless communication with the first clock device, and may be configured to receive a second optical pulse portion of the second optical pulse along the first optical fiber apparatus. The second optical receiving device may be proximal to the second optical transmission device, may be in electrical or wireless communication with the second clock device, and may be configured to receive a first optical pulse portion of the first optical pulse along the first optical fiber apparatus. The first electronic control unit may be in communication with the first clock device, the first optical transmission device, the first optical receiving device, the second clock device, the second optical transmission device, and the second optical receiving device. The first and the second clock devices may be asynchronous during a first time period from when the first optical pulse is emitted from the first optical transmission device to when the second optical pulse portion is received by the first optical receiving device. In such arrangements, the first optical pulse may be received by the second optical receiving device and the second optical pulse being transmitted by the second optical transmission device prior to the second optical pulse portion being received by the first optical receiving device. In such arrangements, the first electronic control unit may instruct a clock adjustment to be made. In such arrangements, the clock adjustment may include a first adjustment of a first clock time of the first clock device, a second adjustment of a second clock time of the second clock device, or a combination of adjustments of both the first and the second clock times such that the first and the second clock devices are synchronized with each other.

In some arrangements, the first optical transmission device and the first optical receiving device may be part of an optical time domain reflectometer or a distributed acoustic sensing unit.

In some arrangements in accordance with any of the arrangements of the foregoing aspect, the clock adjustment may be only the second adjustment In some such arrangements, the second adjustment may be a value equal to half of the sum of the absolute value of the difference between the second clock time when the first optical pulse portion is received by the second optical receiving device and the first clock time when the first optical pulse is emitted by the first optical transmission device and the absolute value of the difference between the first clock time when the second optical pulse portion is received by the first optical receiving device and the second clock time when the second optical pulse is emitted by the second optical transmission device.

In accordance with another aspect, an optical system is characterized by a process. In this process, a first power loss across an optical fiber apparatus that includes an optical fiber is determined for the optical fiber apparatus. In the process, the first power loss is compared to a maximum power loss via an electronic control unit. If the first power loss is no greater than the maximum allowable power loss, then a second power loss across the optical fiber apparatus is determined for the optical fiber apparatus. In the process, an alert is sent, via the electronic control unit, indicating an unacceptable deviation in power loss across the optical fiber apparatus when the first power loss is greater than the maximum allowable power loss.

In accordance with another aspect, an optical fiber apparatus characterization system may include a first optical fiber apparatus, first and second optical transmission devices, a first clock device, a first optical receiving device, a second clock device, a second optical receiving device, and a first electronic control unit. The first optical transmission device may be at a first end of the first optical fiber and may be configured to emit first optical pulses along the first optical fiber. The second optical transmission device may be at a second end of the first optical fiber opposite the first end and may be configured to emit second optical pulses along the first optical fiber apparatus. The first optical receiving device may be proximal to the first optical transmission device. The first optical receiving device may be in electrical or wireless communication with the first clock device. The first optical receiving device may be configured to receive second optical pulse remaining portions of the second optical pulses emitted by the second optical transmission device along the first optical fiber and towards the first optical receiving device. The first optical receiving device may be configured to receive second backscattered light portions reflected by the optical fiber and thereby towards the first optical receiving device from the second optical pulse remaining portions. The second clock device may be synchronized with the first clock device. The second optical receiving device may be proximal to the second optical transmission device. The second optical receiving device may be in electrical or wireless communication with the second clock device. The second optical receiving device may be configured to receive first optical pulse remaining portions of the first optical pulses emitted by the first optical transmission device along the first optical fiber apparatus and towards the second optical receiving device. The second optical receiving device may be configured to receive first backscattered or reflected light portions reflected by the first optical fiber apparatus and thereby towards the second optical receiving device from the first optical pulse remaining portions. The first electronic control unit may be in communication with the first clock device, the first optical transmission device, the first optical receiving device, the second clock device, the second optical transmission device, and the second optical receiving device. The first electronic control unit may be configured to determine a location along the first optical fiber corresponding to a location of a first disturbance external to the first optical fiber apparatus based on a deviation from a first threshold value of a first signal associated with the first backscattered or reflected light portions, e.g., by causing a change of optical signal data corresponding to the first signal, received by the first electronic control unit and a deviation from a second threshold value of a second signal associated with the second backscattered or reflected light portions, e.g., by causing a change of optical signal data corresponding to the second signal received by the first electronic control unit.

In some arrangements according to the foregoing aspect, the deviation from the first threshold value of the first signal may correspond to a reduction in a first power level of the first backscattered or reflected light portions as determined by the first electronic control unit and the deviation from the second threshold value of the second signal may correspond to a reduction in a second power level of the second backscattered or reflected light portions.

In some arrangements according to the foregoing aspect, the deviation from the first threshold value of the first signal may correspond to a change of frequency of the first signal as determined by the first electronic control unit and the deviation from the second threshold value of the second signal may correspond to a change of frequency of the second signal as determined by the first electronic control unit.

In some arrangements according to the foregoing aspect, at least a portion of the first optical fiber apparatus may be translated by the first disturbance.

In some arrangements according to the foregoing aspect, the portion of the first optical fiber apparatus may include an outer region of the first optical fiber apparatus. In some such arrangements, the outer region may be at least partially compressed by the first disturbance.

In some arrangements according to the foregoing aspect, the first electronic control unit may include a first preset value that may correspond to a determined length of the first optical fiber apparatus. In some such arrangements, the first electronic control unit may be configured to determine the location along the first optical fiber apparatus corresponding to the location of the first disturbance based on a first location value computed using the first preset value and first timing data from the second clock device corresponding to a time of travel of the first backscattered or reflected light portions associated with the deviation from the first threshold value of the first signal and a second location value computed using a second preset value and second timing data from the first clock device corresponding to a time of travel of the second backscattered or reflected light portions associated with a deviation from the second threshold value of the second signal.

In some arrangements according to the foregoing aspect, the first threshold value and the second threshold value may be the same value.

In some arrangements according to the foregoing aspect, the first optical receiving device may be further configured to receive third backscattered or reflected light portions of the first optical pulses emitted by the first optical transmission device along the first optical fiber apparatus and towards the second optical receiving device. In some such arrangements, the second optical receiving device may be further configured to receive fourth backscattered or reflected light portions of the second optical pulses emitted by the second optical transmission device along the first optical fiber apparatus and towards the first optical receiving device. In some such arrangements, the first electronic control unit may be further configured to determine the location along the first optical fiber apparatus corresponding to the location of the first disturbance external to the first optical fiber apparatus based on a deviation from a third threshold value of a third signal associated with the third backscattered or reflected light portions, e.g., by causing a change of optical signal data corresponding to the first signal, received by the first electronic control unit from the first optical receiving device and a deviation from a fourth threshold value of a fourth signal associated with the fourth backscattered or reflected light portions, e.g., by causing a change of optical signal data corresponding to the second signal received by the first electronic control unit from the second optical receiving device.

In some arrangements according to the foregoing aspect, the first optical transmission device and the first optical receiving device may be part of a first distributed acoustic sensing unit. In some such arrangements, the second optical transmission device and the second optical receiving device may be part of a second distributed acoustic sensing unit.

In some arrangements according to the foregoing aspect, the first signal may be received by the first electronic control unit from the second optical receiving device. In some such arrangements, the second signal may be received by the first electronic control unit from the first optical receiving device.

In accordance with another aspect, an optical network may include the optical fiber apparatus characterization system according to any of the arrangements of the foregoing aspect and at least one additional optical fiber apparatus characterization system according to any of the arrangements of the foregoing aspect. Any of such optical fiber apparatus characterization systems may be in electrical or optical communication with each other.

In accordance with another aspect, an optical fiber apparatus characterization system may include a first optical fiber apparatus, a first clock device, a first optical transmission device, a first optical receiving device, an optical reflecting element, and a first electronic control unit. The first optical transmission device may be at a first end of the first optical fiber apparatus and may be configured to emit first optical pulses along the first optical fiber apparatus. The first optical receiving device may be proximal to the first optical transmission device. The first optical receiving device may be in electrical or wireless communication with the first clock device. The first optical receiving device may be configured to receive a first backscattered optical pulse portions formed from optical pulse remaining portions of a first optical pulse traveling in a first direction along the first optical fiber apparatus, reflected optical pulse remaining portions of the first optical pulse traveling in a second direction opposite the first direction along the first optical fiber apparatus, and second backscattered optical pulse portions formed from the reflected optical pulse remaining portions along the first optical fiber apparatus. The optical reflecting element may be configured to reflect the optical pulse remaining portions of the first optical pulses and the second backscattered optical pulse portions along the first optical fiber apparatus such that the reflected optical pulse remaining portions and the second backscattered optical pulse portions are received by the first optical receiving device via the first optical fiber apparatus. The first electronic control unit may be in communication with the first clock device, the first optical transmission device, and the first optical receiving device. The first electronic control unit may be configured to determine a location along the first optical fiber corresponding to a location of a first disturbance external to the first optical fiber based on a deviation from a first threshold value of a first signal associated with the first backscattered optical pulse portions and based on a deviation from a second threshold value of a second signal associated with the second backscattered optical pulse portions.

In some arrangements according to the foregoing aspect, the deviation from the first threshold value of the first signal may correspond to a reduction in a first power level of the first backscattered optical pulse portions as determined by the first electronic control unit and the deviation from the second threshold value of the second signal may correspond to a reduction in a second power level of the second backscattered optical pulse portions.

In some arrangements according to the foregoing aspect, the deviation from the first threshold value of the first signal may correspond to a change of frequency of the first signal as determined by the first electronic control unit and the deviation from the second threshold value the second signal may correspond to a change of frequency of the second signal as determined by the first electronic control unit.

In some arrangements according to the foregoing aspect, at least a portion of the first optical fiber may be translated by the first disturbance.

In some arrangements according to the foregoing aspect, the portion of the first optical fiber apparatus may include an outer region of the first optical fiber apparatus. In some such arrangements, the outer region may be at least partially compressed by the first disturbance.

In some arrangements according to the foregoing aspect, the first electronic control unit may include a first preset value that may correspond to a determined length of the first optical fiber apparatus. In some such arrangements, the first electronic control unit may be configured to determine the location along the first optical fiber apparatus corresponding to the location of the first disturbance based on a first location value computed using the first preset value and first timing data from the first clock device corresponding to a time of travel of the first backscattered optical pulse portions associated with the deviation from the first threshold value of the first signal and a second location value computed using a second preset value and second timing data from the first clock device corresponding to a time of travel of the second backscattered optical pulse portions associated with a deviation from the second threshold value of the second signal.

In some arrangements according to the foregoing aspect, the first optical transmission device and the first optical receiving device may be part of a distributed acoustic sensing unit.

In some arrangements according to the foregoing aspect, the first and the second signals may be received by the first electronic control unit from the first optical receiving device.

In accordance with another aspect, an optical network may include the optical fiber apparatus characterization system according to any of the arrangements of the foregoing aspect and at least one additional optical fiber apparatus characterization system according to any of the arrangements of the foregoing aspect. Any of such optical fiber apparatus characterization systems may be in electrical or optical communication with each other.

### BRIEF DESCRIPTION OF THE DRAWINGS

By way of description only, embodiments of the present disclosure are described herein with reference to the accompanying figures, in which:

FIG. 1 is a schematic diagram of a fiber optic system as known in the prior art;

FIG. 2A is a schematic diagram of a fiber optic network providing for the characterization of optical fibers within the network in accordance with an embodiment;

FIG. 2B is a schematic diagram of a fiber optic system within the fiber optic network of FIG. 2A in accordance with another embodiment;

FIG. 2C is a plot of optical power level versus distance along an optical fiber within the fiber optic network of FIG. 2A in accordance with another embodiment;

FIG. 3A is a schematic diagram of a fiber optic system for the characterization of an optical fiber in accordance with another embodiment;

FIG. 3B is a plot of optical power level versus distance along the optical fiber of FIG. 3A in accordance with another embodiment;

FIG. 4 is a schematic diagram of a fiber optic system for the synchronization of clock devices within the system in accordance with another embodiment;

FIG. 5 is a schematic diagram of a fiber optic system for the assessment of power loss along an optical fiber of the system in accordance with another embodiment;

FIG. 6 is a schematic diagram of a portion of a fiber optic system using an optical fiber ring for the characterization of an optical fiber in accordance with another embodiment;

FIG. 7A is a schematic diagram of a fiber optic system for use in identifying a location of an external disturbance in accordance with another embodiment;

FIG. 7B is a plot of optical power level versus time showing the effect of an external disturbance on an optical pulse in the fiber optic system of FIG. 7A;

FIG. 8A is a schematic diagram of a fiber optic system for use in identifying a location of an external disturbance in accordance with another embodiment;

FIG. 8B is a plot of optical power level versus time in the fiber optic system of FIG. 8A; and

FIG. 9 is a schematic diagram of a fiber optic network for use in identifying the locations of external disturbances in accordance with another embodiment.

### DETAILED DESCRIPTION

As used herein, “optical signals” are ones that are created by the transmission of light beams. Such signals may be formed by modulating the intensity of light beams from a light source or by modulating the frequency of the transmission of light beams from a light source. The transmission of optical pulses provides optical signals. Additionally and unless otherwise indicated, where the term “optical fiber” is used in this detailed description section, the term is intended to be encompassed by the term “optical fiber apparatus” and to refer to an optical fiber by itself as well as to refer to a connected set of optical fibers, optical connectors, optical adapters, and the like that connect the set of optical fibers to form a continuous optical fiber linc.

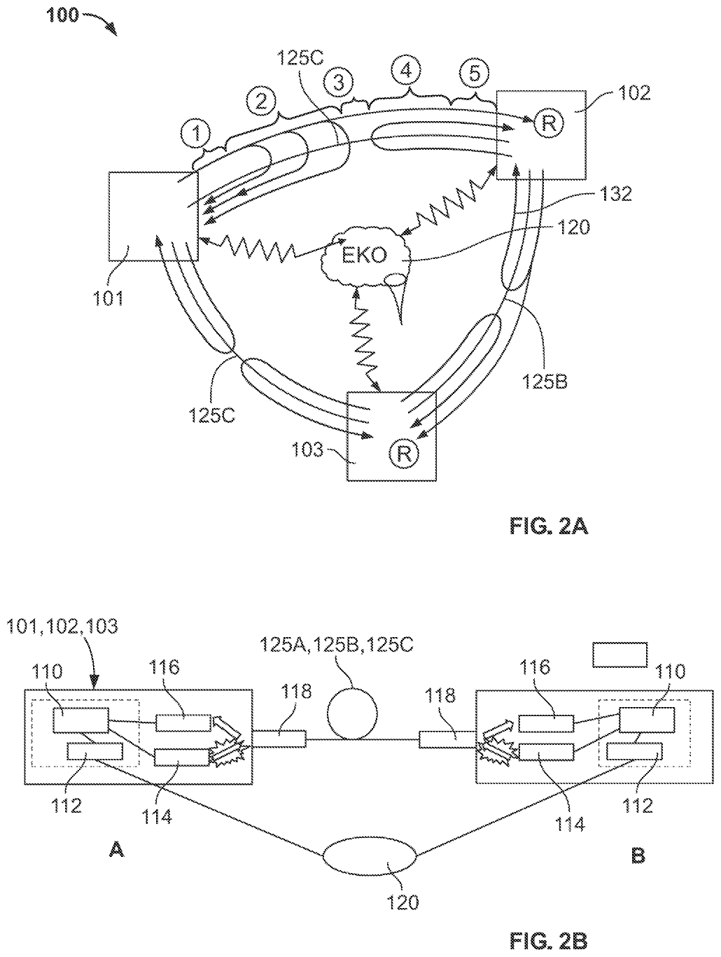

Referring now to FIGS. 2A and 2B, fiber optic network 100 includes an optical fiber control and characterization system configured for both communicating between nodes of the network and identifying locations of optical signal disruptions along an entirety of one or more optical fibers within the network. As shown, fiber optic network 100 includes optical fiber characterization units 101, 102, 103, although fiber optic networks in accordance with the present disclosure may include two or more optical fiber characterization units, e.g., 10 units, 100 units, 1000 units, etc., as needed. With reference to FIG. 2B, optical fiber characterization units 101, 102, 103 each include local control unit 110, communication device 112, optical transmission device 114, optical receiving device 116, and coupler 118. Optical fiber 125A extends between optical fiber characterization unit 101 and optical fiber characterization unit 102 to form one fiber optic system, optical fiber 125B extends between optical fiber characterization unit 102 and optical fiber characterization unit 103 to form another fiber optic system, and optical fiber 125C extends between optical fiber characterization unit 101 and optical fiber characterization unit 103 to form yet another fiber optic system. Each of optical fiber characterization units 101, 102, 103 is in communication with central control unit 120, as shown in FIG. 2A, which may be or include but is not limited to being or including an electronic control unit. One central control unit that may be used is the EKO® intelligent optical fiber management system by Go!Foton, which may be remote from the rest of the system. In this example, which is not intended to be limiting, each of optical fiber characterization units 101, 102, 103 is in optical communication with two other optical fiber characterization units.

To perform an assessment of optical fibers 125A, 125B, 125C, local control unit 110 of optical fiber characterization unit 101, 102, 103 on one end of the optical fiber being assessed directs optical transmission device 114, via an electrical connection between the local control unit and the optical transmission device, to transmit an optical pulse which is conveyed along the optical fiber via one coupler 118 and received via another coupler 118 by optical receiving device 116 of the optical fiber characterization unit on the opposing end of the optical fiber. Local control unit 110 of the other optical fiber characterization unit 101, 102, 103 confirms receipt of an optical pulse portion of the optical pulse by optical receiving device 116 on that optical fiber characterization unit via an electrical connection between that local control unit and that optical receiving device. Upon confirming receipt of the optical pulse and via a connection between that local control unit 110 and central control unit 120, local control unit 110 conveys to the central control unit that the optical pulse was received by the respective one of optical fiber characterization units 101, 102, 103. Connections between each local control unit 110 and central control unit 120 may be any one or any combination of electrical (e.g., via wires, transformers, other electrical componentry such as resistors), optical (e.g., via fiber optic cables, optical connectors, splitters), and wireless connections. In some configurations, one or more of local control units 110 of optical fiber characterization units 101, 102, 103 and central control unit 120 may be on the same network, such as but not limited to a local area network (LAN) or a cloud-based wide area network (WAN). Central control unit 120 stores information from local control units 110 in the form of a database while also, periodically or at preset intervals, providing instructions to the local control units to initiate the emission of optical pulses by respective optical transmission devices 114, e.g., for the purpose of characterizing an optical fiber as described herein. However, local control units 110 may be used to otherwise control the operation of optical fiber characterization units 101, 102, 103.

Still referring to FIGS. 2A and 2B, each local control unit 110 includes a clock device (not shown) as known to those skilled in the art. When the clock devices of local control units 110 at opposing ends of optical fiber 125A, 125B, 125C are synchronized such they have the same time, the time that the local control unit directs an associated optical transmission device 114 to convey an optical pulse may be sent by that local control unit to central control unit 120 via communication device 112 and, similarly, the time that the local control unit associated with optical receiving device 116 that receives the optical pulse receives an electrical signal that the optical pulse was received likewise may be sent by that local control unit to the central control unit. In this instance, the two times are registered by the central control unit which determines a difference between them corresponding to a registered time for the optical pulse to travel from optical transmission device 114 to optical receiving device 116. With a known optical fiber material and the clock devices at opposing ends of optical fiber 125A, 125B, 125C synchronized, the speed at which the optical pulse is conveyed along optical fiber 125A, 125B, 125C is known such that the length of the optical fiber may be determined as the product of that speed and the registered time for the optical pulse to travel from optical transmission device 114 to optical receiving device 116. With or without the clock devices at opposing ends of optical fiber 125A, 125B, 125C having been synchronized and when only a single optical pulse is emitted by optical transmission device 114, local control unit 110 at a pulse receiving end of optical fiber 125A, 125B, 125C can retrieve a power level of the single optical pulse received by optical receiving device 116. In some arrangements, the power level may be measured by a fiber optic power meter, which may be part of optical receiving device 116, as known to those skilled in the art. Central control unit 120 can then compare the measured power level of the optical pulse received by optical receiving device 116 against a preset or similarly measured power level of the optical pulse emitted by the optical transmission device 114 to determine a power loss of the single emitted pulse from when the pulse was emitted by optical transmission device 114 to when the pulse was received by optical receiving device 116, when no other pulses are emitted so as to isolate the emitted pulse.

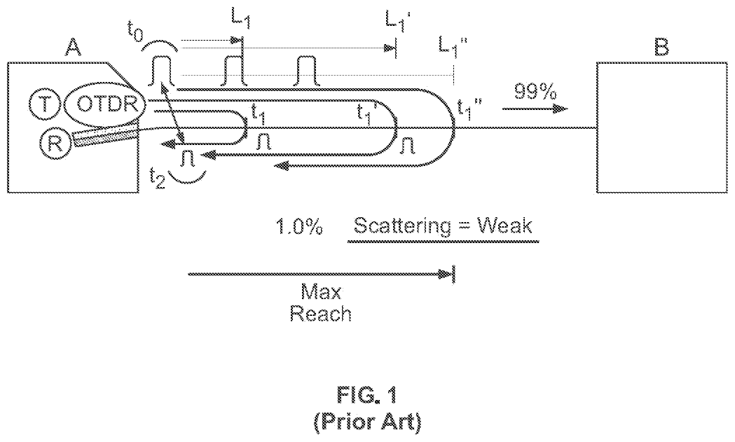

In some arrangements, optical transmission device 114, optical receiving device 116, and coupler 118 of optical fiber characterization units 101, 102, 103 may be parts of an OTDR device. With reference to FIG. 2A, optical pulses conveyed by optical transmission device 114 may be scattered by optical fiber 125A, 125B, 125C such that a portion of the scattered light may be received by optical receiving device 116 of the same OTDR device. In this manner, potential optical fiber disruptions along significant portions of optical fibers 125A, 125B, 125C may be identified. In the example shown in FIG. 2A, each of optical fiber characterization units 101, 102, 103 includes an OTDR device emitting optical pulse portions 132 such that potential optical fiber disruptions may be identified along significant opposing portions of each of the three optical fibers 125A, 125B, 125C as described above with respect to FIG. 1 as to the use of OTDR devices.

In some arrangements of optical fiber characterization units 101, 102, 103 that are in optical communication with more than one optical fiber, a single optical transmission device 114 and a single optical receiving device 116, which may be part of the same OTDR device, may be part of an optical fiber characterization unit 101, 102, 103 for optical communication with at least a plurality of optical fibers. In such arrangements, an optical switch such as those described in U.S. Patent Application Publication No. 2022/0003935 A1, the entirety of the disclosure of which is hereby incorporated herein by reference, may be in optical connection with each of the single optical transmission device 114 and the single optical receiving device 116 and employed to switch an optical connection of those devices with one optical fiber, and thereby with another optical characterization unit, to an optical connection with another optical fiber, and thereby a different optical characterization unit. In some other arrangements of optical fiber characterization units 101, 102, 103 that are in optical communication with a plurality of optical fibers, such optical fiber characterization units may include a set of a single optical transmission device 114, a single optical receiving device 116, and single coupler 118 for each optical fiber with which the optical fiber characterization unit is in communication. In such instances, each set of a set of a single optical transmission device 114, a single optical receiving device 116, and a single coupler 118 may be an OTDR device such that the optical fiber characterization unit 101, 102, 103 includes a plurality of OTDR devices.

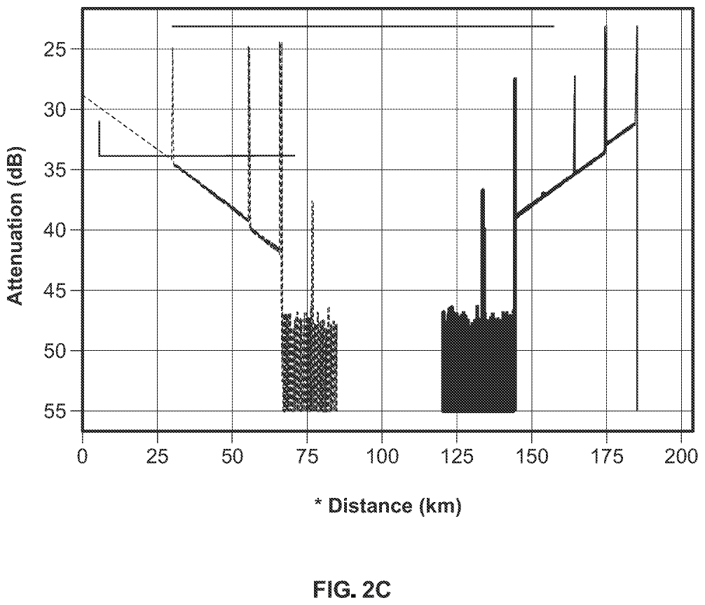

As shown in FIG. 2A, the lengths of optical fibers 125A, 125B, 125C are too great such that the maximum reach of optical pulse portions 132 emitted by opposing optical transmission devices 114 among optical fiber characterization units 101, 102, 103 does not cover an entirety of corresponding optical fibers 125A, 125B, 125C. Indeed, with further reference to FIGS. 2A and 2C, optical fiber disruptions are generally identified using traditional OTDR devices within optical fiber characterization units 101, 102, 103 only in intermediate zones 2 and 4 identified in FIG. 2A. In particular, a diminishing power level of optical pulses the further the optical pulses are from the OTDR device from which the pulses were emitted is demonstrated in the plot of power level versus distance along an optical fiber being evaluated in a system like that shown in FIGS. 2A and 2B. The left graph in the plot of FIG. 2C shows the power level at various distances for optical pulse portions 132 emitted along optical fiber 125A, 12B, 125C from the OTDR device on one end of the fiber, the right graph in the plot shows the power level at various distances for optical pulse portions 132 emitted from the OTDR device on the other end of the fiber, and the gap between the left and the right graphs shows the portion of the optical fiber, e.g., at 100 km, at which the optical pulses emitted from optical transmission devices 114 are not reflected back by the optical fiber to the respective optical receiving devices 116 of the same optical fiber characterization units 101, 102, 103 from which the pulses were emitted. The various spikes (see also FIG. 3B) in the graph indicate disruptions along the optical fiber 125A, 12B, 125C that may require inspection or other further investigation if such spikes are unexpected. Often, and in this example, the spikes are caused by connectors inserted along an optical fiber line that reflect optical pulses emitted from optical transmission devices 114 and thus are to be expected.

However, with a known time for an optical pulse to travel from optical transmission device 114 to optical receiving device 116 (and thus with a known initial length of optical fiber 125A, 125B, 125C), e.g., when the optical fiber 125A, 125B, 125C is first installed or at a later date, delays in the length of time for optical pulses to travel from optical transmission device 114 to optical receiving device 116 indicate that there could be an undesirable change in the length of the optical fiber (or even an intentional change in the length due to the addition of an optical fiber to the original optical fiber or fibers in the context of an optical fiber apparatus having more than one optical fiber defining the original length) that requires further investigation. Referring again to FIG. 2C, the distance provided along the X-axis of the plot must first be determined from the current length of optical fiber 125A, 125B, 125C, which itself must be determined from the length of time for an optical pulse to travel from optical transmission device 114 to optical receiving device 116. Without this prior length determination, the distance on the far right of the right graph at which the optical pulse is emitted from optical transmission device 114 (on the right side), relative to the left graph, and therefore the gap between the left and the right graphs would be unknown.

In some alternative arrangements, a characterization unit may include multiple transmission and receiving devices and a separate coupler associated with each set of the multiple transmission and receiving devices. In such arrangements, local control units may direct only one associated pair of transmission and receiving devices or pluralities of transmission and receiving devices, including all transmission and receiving devices, for a single characterization unit. In such arrangements, communication devices may be in communication with only one local control unit or pluralities of local control units, including all local control units, for a single characterization unit. In some arrangements, a communication device and local control unit optionally may be part of a controller device, as indicated by the dashed lines around local control units 110 and communication devices 112 in FIG. 2B.

Referring now to FIGS. 3A and 3B, fiber optic system 200 is the same as the fiber optic systems discussed with respect to fiber optic network 100 except that optical fiber 225 is sufficiently shorter than optical fibers 125A, 125B, 125C such that optical pulse portions 232 both conveyed from optical transmission devices 114 at opposite ends of optical fiber 225 and received by optical receiving devices 116 on the same ends as the optical transmission devices from which the pulses were emitted travel along the optical fiber and over a same region of the optical fiber. Fiber optic system 200 may be part of a larger fiber optic network that may include multiple fiber optical systems like fiber optic system 200 or may be used in conjunction with systems like that discussed above with respect to fiber optic network 100.

Due to the maximum reaches of optical pulse portions 232 that are emitted from received by the same opposing optical fiber characterization units 101, 102, 103, an assessment of optical fiber 225 having any length up to twice the maximum reach of optical pulse portions 232 may be made to determine specific locations of optical signal disruption along such a fiber. The distance provided along the X-axis of the plot shown in FIG. 3B should first be determined, in the same manner of preparing the plot shown in FIG. 2C, from the current length of optical fiber 225, which itself must be determined from the length of time for an optical pulse travel from optical transmission device 114 to optical receiving device 116 of fiber optic system 200. This prior length determination would provide the distance to be provided on the far right of the right graph at which the optical pulse is emitted from optical transmission device 114 (on the right side), relative to the left graph. Alternatively, for examples of optical pulse portions 232 both emitted from and received by the same opposing optical fiber characterization units 101, 102, 103, shared regions of travel of the emitted optical pulses may be identified using the plot, as in the example of FIG. 3B, by aligning multiple spikes of equal magnitude on the plot as with the two sets of aligned spikes of the graphs in FIG. 3B. With a known range for the OTDR device or for connectors along an optical fiber line, a length of the complete optical fiber line could be extrapolated from the properly aligned graphs on the plot.

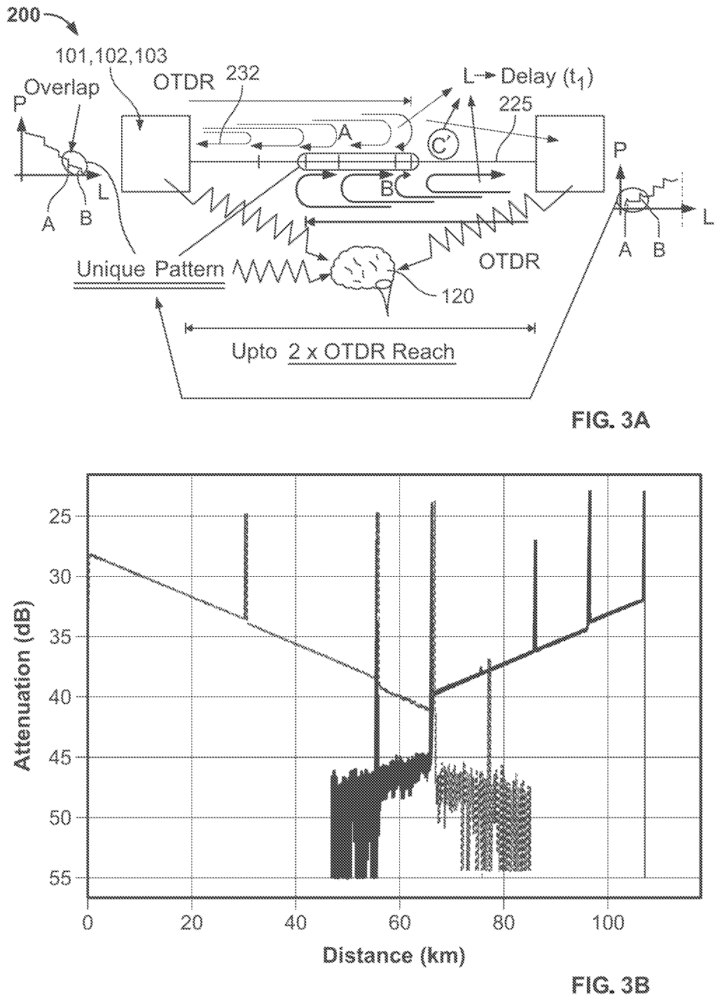

Referring now to FIG. 4, in fiber optic system 300, so that a length of optical fibers, such as optical fibers 125A, 125B, 125C, 225, extending between optical fiber characterization units 101, 102, 103 can be determined based on a difference in the time an optical pulse is registered by central control unit 120 as having been emitted by optical transmission device 114 and the time the optical pulse is registered by the central control unit as having been received by optical receiving device 116, the pair of clock devices 150, 350 of local control units 110 of the respective optical fiber characterization units must be synchronized. As shown in FIG. 4, optical fiber characterization unit 302 may be substantially the same as optical fiber characterization unit 101, 102, 103 with the exception that optical fiber characterization unit 302 includes an optical reflecting element 340, e.g., a mirror, configured to reflect at least parts of the optical pulses emitted by optical transmission device 114 of optical fiber characterization unit 101, 102, 103 along an optical fiber such as optical fibers 125A, 12B, 125C, 225. In this example, optical reflecting element 340 may be configured such that other parts of the optical pulses not reflected by the optical reflecting element 340 are received by optical receiving device 116 via the optical fiber. Clock devices 150, 350 of local control units 110 of optical fiber characterization units 101, 102, 103, 302 are asynchronous during a first time period from when optical pulse 332 is emitted from optical transmission device 114 to when portions of the parts of the optical pulses reflected by optical reflecting element 340 are received by optical receiving device 116 of optical fiber characterization unit 101, 102, 103 from which the optical pulse is emitted.

To synchronize clock devices 150, 350, a total clock device time adjustment Δt of the clock devices of fiber optic system 300 is directed by central control unit 120. Time adjustment Δt is equal to half of the sum of the clock time to of clock device 150 when the optical pulse is registered by local control unit 110 of optical fiber characterization unit 101, 102, 103 or central control unit 120 as having been emitted by optical transmission device 114 and the clock time t2 of clock device 150 when the portions of the parts of the optical pulses reflected by the optical reflecting element are registered by local control unit 110 of optical fiber characterization unit 101, 102, 103 or central control unit 120 as having been received by optical receiving device 116 of optical fiber characterization unit 101, 102, 103 less the clock time t1′ of clock device 350 when the part of the optical pulse received by optical receiving device 116 of optical fiber characterization unit 302 is registered by local control unit 110 of optical fiber characterization unit 302 or central control unit 120 as having been received, i.e., Δt=(t0+t2)/2−t1′. The clock adjustment may be split between clock devices 150, 350 of fiber optic system 300 or may be made to only one of the pair of clock devices, e.g., clock device 350 of optical fiber characterization unit 302, such that clock device 150 of optical fiber characterization unit 101, 102, 103 is synchronized with clock device 350.

Referring again to FIGS. 2A and 2B, in alternative arrangements, clock devices of pairs of optical fiber characterization units 101, 102, 103 may be synchronized without an optical reflecting element such as optical reflecting element 340. In such configurations, the total clock device time adjustment Δt is equal to half of the sum of the absolute value of the difference between a clock time t1′ of one optical fiber characterization unit (e.g., right side unit) that received optical pulse portion 132 of an optical pulse from another optical fiber characterization unit (e.g., left side unit) when the optical pulse portion is so received and a clock time t0 when an optical pulse is emitted from the other optical fiber characterization unit (e.g., left side unit) and the absolute value of the difference between a clock time t1 of the other optical fiber characterization unit (e.g., left side unit) when a second optical pulse portion is received by the other optical fiber characterization unit (e.g., left side unit) and a clock time to′ of the one optical fiber characterization unit (e.g., right side unit) when the second optical pulse is emitted by the one optical fiber characterization unit (e.g., right side unit).

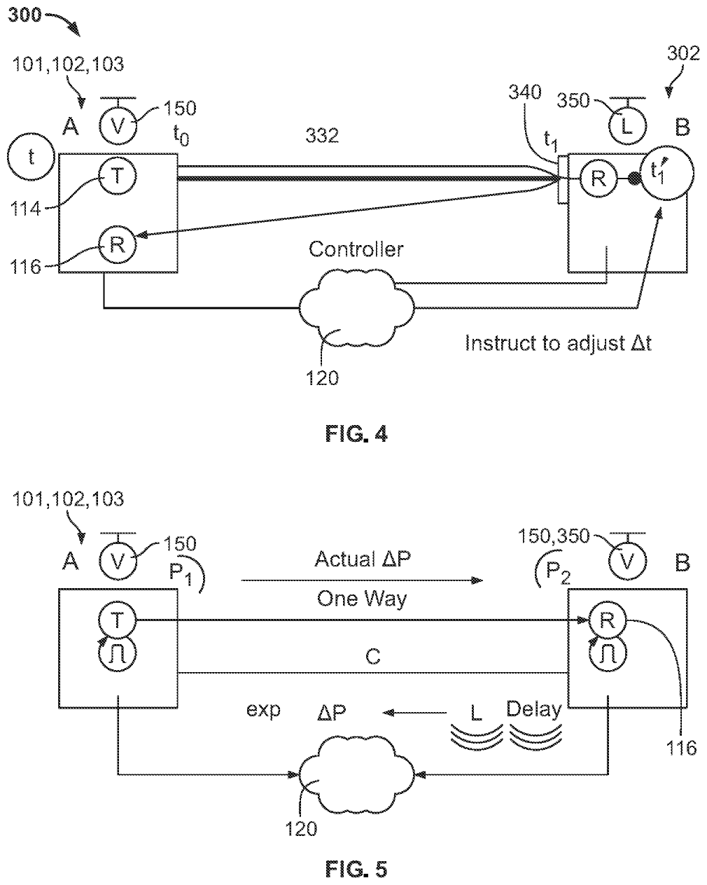

Referring now to FIG. 5, once clock devices 150, 350 of optical fiber characterization units 101, 102, 103, 302 are synchronized, a power loss along optical fiber 125A, 125B, 125C, 225 extending between the optical fiber characterization units can be determined, either on-demand when central control unit 120 instructs one or both optical fiber characterization units on ends of the optical fiber to emit an optical pulse or continuously (e.g., at a preset sampling rate or at a maximum sampling rate achievable by the optical fiber characterization unit) as a default or as instructed by the central control unit. With a known length of optical fiber 125A, 125B, 125C, 225 determined and a known speed of optical pulses being emitted from optical transmission device 114 as discussed above with respect to FIGS. 2A and 2B, a power loss of optical pulses or a series of optical pulses sampled on an ongoing basis, e.g., at preset intervals can be determined. With reference to FIGS. 2A and 2C, in fiber optic systems in which the lengths of optical fibers 125A, 125B, 125C are too great such that the maximum reach of optical pulse portions 132 emitted by opposing optical transmission devices 114 among optical fiber characterization units 101, 102, 103 does not cover an entirety of corresponding optical fibers 125A, 125B, 125C, an optical power loss across an optical fiber can be used to isolate central region 3 (or, at a minimum, isolate end region 1, central region 3, and end region 5 as shown in FIG. 2A) of the optical fiber (see FIG. 2A) as the region having an optical fiber disruption causing the power loss. Using power level data such as that shown in FIG. 2C, where no unexpected spikes are identified based on the feedback obtained from opposing optical receiving devices 116 due to backscattered and/or reflected optical pulse remaining portions, a power loss along the optical fiber likely would be caused by one or more optical fiber disruptions in any one or any combination of end region 1, central region 3, and end region 5 as shown in FIG. 2A.

With reference to FIGS. 2A, 2B, 4, and 5, in some arrangements when clock devices 150, 350 of optical fiber characterization units 101, 102, 103, 302 are synchronized, one or both optical fiber characterization units 101, 102, 103, 302 emitting optical pulses from optical transmission device 114 of the one optical fiber characterization unit may communicate a power level of an emitted optical pulse or emitted series of optical pulses to central control unit 120 and the opposing optical fiber characterization unit may communicate a power level of a received optical pulse portion of the emitted optical pulse or received series of optical pulse portions of the emitted series of optical pulses received by optical receiving device 116 of such opposing optical fiber characterization unit to the central control unit. The power level of the received optical pulse portions may be obtained at specific sampling intervals based on a known time for the optical pulses to travel from optical transmission device 114 to optical receiving device 116 as described above. Optical fiber characterization units 101, 102, 103, 302 emitting the optical pulses in these arrangements may be alternated between the unit on one of the optical fiber and the unit on the other end of the optical fiber. In this manner and with an appropriate sampling interval for each optical receiving device 116, optical transmission device 114 of each optical fiber characterization unit 101, 102, 103, 302 does not emit an optical pulse until the optical receiving device of that same optical fiber characterization unit receives the optical pulse portion from the optical transmission device of the opposing optical fiber characterization unit such that the alternating optical pulses do not overlap.

In such arrangements, central control unit 120 may determine power losses between optical fiber characterization units 101, 102, 103, 302 for an optical fiber based on respective differences between the power levels of the emitted optical pulses communicated to the central control unit from each optical fiber characterization unit emitting the optical pulses and the power levels of the received optical pulse portions communicated to the central control unit from each opposing optical fiber characterization unit. Central control unit 120 may then compare each determined power loss to a maximum allowable power loss preset in the central control unit. In some arrangements, the maximum allowable power loss may be a threshold L₁+L₂ determined by adding a power loss L₁ determined for an optical fiber between characterization units 101, 102, 103, 302 at a specific time, e.g., at the time the optical fiber is installed or another preset time, such as but not limited to when an investigation of an optical fiber is performed, and a deviation L₂ from that power loss deemed to be acceptable before a further investigation of that optical fiber and potentially its associated optical fiber characterization units is needed. The deviation may be a value based on empirical data gathered for these systems.

When a determined power loss is greater than the preset maximum allowable power loss, central control unit 120 may send an alert, e.g., a text message or an email message, to a technician or a central office, e.g., over a cloud network, to indicate the deviation from the maximum allowable power loss. For an investigation, in some arrangements, optical fiber characterization units 101, 102, 103, 302 may be used in the manner described above with respect to FIGS. 2A-3B to ascertain optical fiber characteristics such as length and optical fiber disruptions. In such arrangements, opposing optical fiber characterization units 101, 102, 103, 302 may be OTDR devices on opposing ends of the optical fiber to be characterized that may be alternately operated. In this manner, one OTDR device may emit an optical pulse and thereby be used to detect optical fiber disruptions in at least region 2 (per FIG. 2A) when its opposing OTDR device is not operating, and the opposing OTDR device may emit an optical pulse and thereby be used to detect optical fiber disruptions in at least region 4 (per FIG. 2A) when the one OTDR device is not operating.

Optical fiber characterization unit 101, 102, 103, 302 may not be configured to detect Rayleigh backscattered and/or reflected optical pulse remaining portions on a continual basis. In some such arrangements, optical fiber characterization unit 101, 102, 103, 302 may be used solely for power loss determinations on a continuous basis. For example, the OTDR feature of optical fiber characterization unit 101, 102, 103, 302 to detect backscattered and/or reflected optical pulse remaining portions may not be continuously active and instead may be active only at prescheduled periods, which may be set via central control unit 120 and local control unit 110, or when instructed to be active by either one or both of local control unit 110 and central control unit 120. OTDR features to detect backscattered and/or reflected optical pulse remaining portions also may be used when a new optical fiber is inserted so that central control unit 120 can detect the location of ends of a new optical fiber inserted between the OTDR devices acting as optical fiber characterization unit 101, 102, 103, 302. In these instances, backscattered and/or reflected optical pulse remaining portions detected by the OTDR devices may correspond to connectors and adapters used to insert the optical fiber in the fiber optic line.

When the OTDR features are not active, local control unit 110 may not communicate data associated with the receipt of backscattered and/or reflected optical pulse remaining portions to central control unit 120 or the local control unit 110 may communicate such data but the central control unit may not analyze or even record such data. In this manner, any one or any combination of the amount of data to be stored is limited, the usage of hardware to collect and transfer the data is limited, and system maintenance needs are limited, thereby improving overall operational efficiency.

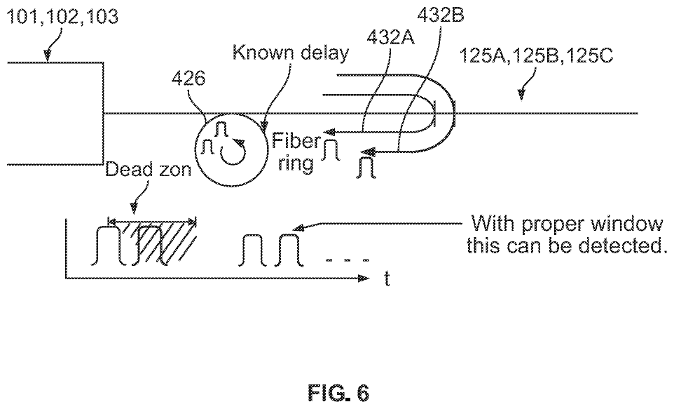

Referring now to FIG. 6, fiber ring 426 is formed by coiling a section of optical fiber 125A, 125B, 125C, 225 within a fiber optic system like those in fiber optic network 100 and fiber optic systems 200, 300. More than fiber ring may be included along the optical fiber in some arrangements. Fiber ring 426 introduces a known optical fiber disruption along optical fiber 125A, 125B, 125C, 225 while also allowing for a greater length of optical fiber to be used between optical fiber characterization units 101, 102, 103. Each coil will be detected by backscattered or reflected pulse remaining portions of an optical pulse, assuming a coil of minimum diameter (i.e., one that is not too small such that some of the coils go undetected by optical receiving device 116). In this manner, the use of the coils of fiber ring 426 provides a time delay before optical receiving device 116 detects an optical pulse remaining portion subsequent to an optical pulse remaining portion just detected. Due to limitations on the resolution of optical receiving device 116, optical signal disruptions at locations along the optical fiber may be too close together. To compensate, a sampling time of optical receiving device 116 may be offset by a small amount at preset intervals so that optical pulse remaining portions backscattered or reflected by otherwise undetected portions of the optical fiber are detected. Such offset of optical receiving device 116 maybe returned to the prior sampling condition at the same preset interval during operation. In some arrangements, more than two offsets may be made and thereby more than two sets of data may be collected. Of course using such offsets will decrease the number of samples that may be taken for each window of data collection applied within a given time period.

With reference to FIGS. 2A and 6, fiber ring 426 can be placed along optical fiber regions 1 and 5 of optical fiber optical fiber 125A, 125B, 125C, 225 to increase the fiber length in those regions. Doing so will allow for optical fiber disruption detections in those regions that otherwise may not occur because optical receiving device 116 may not be able to detect such disruptions that occur after emission of an optical pulse. In this manner and by applying the procedures discussed above with respect to regions 2, 3, and 4 shown in FIG. 2A, an optical fiber may be characterized across its entire or nearly its entire length.

In some arrangements, the sampling time offset could be made even without the use of the fiber ring. However, the available amount of offset is more limited in these circumstances.

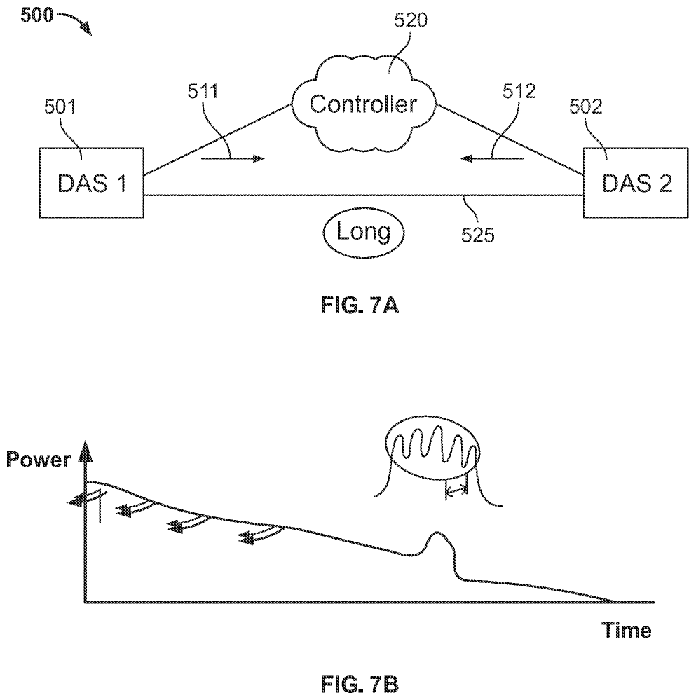

Referring now to FIG. 7A, fiber optic system 500 is similar to the fiber optic systems within fiber optic network 100 such as those shown in FIG. 2B except that, most notably, optical fiber characterization units 501, 502 are in the form of distributed acoustic sensing (DAS) units on opposite ends of optical fiber 525. As shown, fiber optic system 500 further includes central control unit 520, which may be the EKO® intelligent optical fiber management system by Go!Foton, in electrical or optical communication with DAS units 501, 502. DAS units 501, 502 are configured to send pulses of light in respective opposite directions 511, 512 down optical fiber 525 and to monitor optical pulse remaining portions from one of the DAS units that reach the other of the pair of DAS units. In some arrangements, DAS units may be configured to receive and interpret the Rayleigh backscattering of light that results from the emission of an optical pulse.

In an exemplary arrangement of fiber optic system 500, optical pulses may be transmitted continuously by DAS units 501, 502, and the corresponding optical pulse remaining portions of the pulses of light may be received and converted into digital data continuously by the other of the DAS units. Like optical fiber characterization units 101, 102, 103 described previously herein, each of DAS units 501, 502 may include an optical transmission device configured for emitting optical pulses and an optical receiving device configured for receiving optical pulses. Central control unit 520 may be configured for receiving optical or electrical signals corresponding to the optical pulses received by the optical receiving device to provide data regarding the optical pulses received by the optical receiving device, e.g., light intensity and optical power level data, at specific times or time periods as measured by clock devices of fiber optic system 500 associated with optical fiber characterization units 501, 502. In some arrangements, central control unit 520 may be configured to manipulate the data regarding the optical pulses from the time domain into the frequency domain to provide for further analysis, e.g., to identify changes in optical signal frequency.

With reference to FIG. 7B, in operation, when one of the optical fiber characterization units 501, 502 emits an optical pulse and the other of the optical fiber characterization units receives the optical pulse remaining portions of the emitted optical pulse, an optical power level of the received optical pulse remaining portions may be at peak power level for the light received by the optical receiving device of the receiving DAS unit. This peak power is demonstrated at time t=0 on the far left of the plot shown in FIG. 7B. As further shown by the region of the plot in FIG. 7B highlighted by “backscatter arrows,” backscattered light portions reflected from the optical receiving device of receiving DAS unit 501, 502 continue to be received by the optical receiving device at lower and lower power levels over time. If a disturbance occurs external to optical fiber 525, sound pressure caused by the disturbance may cause the optical fiber to translate, and in some instances, to slightly compress at an outer region of the optical fiber so as to disrupt an emitted optical pulse as it passes by a compressed or at least translated, i.e., shifted, inner region of the optical fiber corresponding to the outer region. In this manner, portions of optical pulse remaining portions that reach the compressed or at least translated inner region of optical fiber 525 are reflected back as backscattered light portions to the optical receiving device of receiving DAS unit 501, 502 at a higher power level relative to the power level of backscattered light portions received by the optical receiving device immediately prior, as demonstrated in the spiked region of FIG. 7B. Additionally, backscattered light portions that are reflected back at locations beyond the compressed or at least translated inner region of optical fiber 525 are reflected back to the optical receiving device at a further reduced power level due to the smaller area in the optical fiber for those backscattered light portions to return back to the optical receiving device.

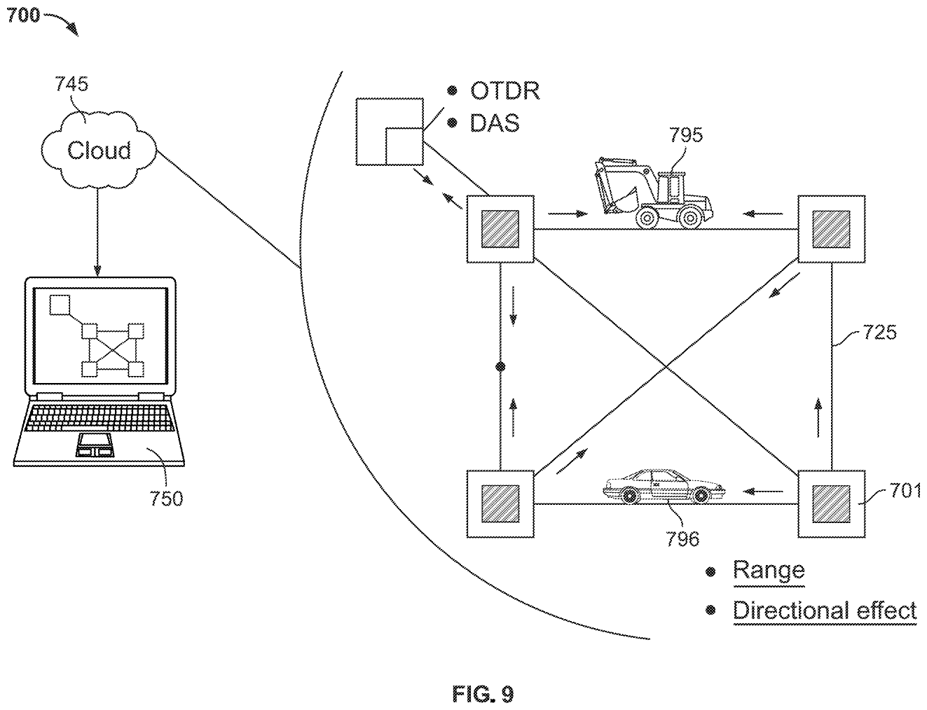

A preset value corresponding to a length of optical fiber 525 is stored in a memory within central control unit 520. As such, in operation of fiber optic system 500, time data associated with the data received by central control unit 520 from the optical receiving device that corresponds to the spiked region in the plot of FIG. 7B is used by the central control unit, or remote office 750 (see FIG. 9) in communication with the central control unit, in conjunction with the preset value to determine a distance along optical fiber 525 at which the inner region of the optical fiber is compressed or at least translated. This determined distance may then be used by remote office 750 having known locations of the optical fibers to locate an approximate location of the disturbance (see FIG. 9).

Referring again to FIG. 7A, optical signal data corresponding to compressed or at least translated inner regions of optical fibers caused by external surfaces as just described is different depending on the direction from which an optical pulse is emitted along optical fiber 525. By having DAS units 501, 502 emit optical pulses from opposite directions, different sets of optical signal data can be collected about the optical fiber 525 to provide a greater opportunity for central control unit 520 or remote office 750 to more clearly identify a disturbance acting on optical fiber 525. Preferably, when using DAS units 501, 502 for disturbance location identification, the DAS units emit optical pulses at times offset from each other, as may be directed by central control unit 520, to avoid overlapping signals from both DAS units being received by the same optical receiving device at the same time. However, in some arrangements with appropriate digital filters known to those skilled in the art, disturbance location identification could still be performed using DAS units 501, 502 even when the DAS units simultaneously emit optical pulses.

In addition to changes in optical power level caused by external disturbances, changes in the frequency of the optical signals of emitted pulses can be detected by DAS units 501, 502. Thus, an analysis of optical signal data by central control unit 520 in the frequency domain can also be used to detect external disturbances and thereby be use for identifying the location of the external disturbance given a preset value for a length of an optical fiber.

In a modified arrangement using fiber optic system 500, one of a dual end “entanglement” system, optical pulse remaining portions of pulses of light emitted from one DAS unit 501, 502 are received by the other DAS unit as in the arrangement just described. However, in this arrangement and like a traditional OTDR unit, the optical receiving device of DAS unit 501, 502 from which the optical pulse is emitted receives backscattered light portions from the emitted optical pulse as the pulse travels towards the other DAS unit and communicates data associated with those backscattered light portions to central control unit 520. As backscattered light portions reflected back from an interaction of the emitted optical pulse with a compressed or at least translated inner region of optical fiber 525 have a spiked power level, power level data associated with such backscattered light portions received by the optical receiving device of pulse-emitting DAS unit 501, 502 can also be used to identify a location of a disturbance sufficiently heard or felt by optical fiber 525. In this manner, data corresponding to relatively higher power backscattered light portions closer to pulse-emitting DAS unit 501, 502 can be obtained and communicated by the optical receiving device of the pulse-emitting DAS unit whereas data corresponding to relatively higher power backscattered light portions closer to pulse-receiving DAS unit 501, 502 can be obtained and communicated by the optical receiving device of the pulse-receiving DAS unit.

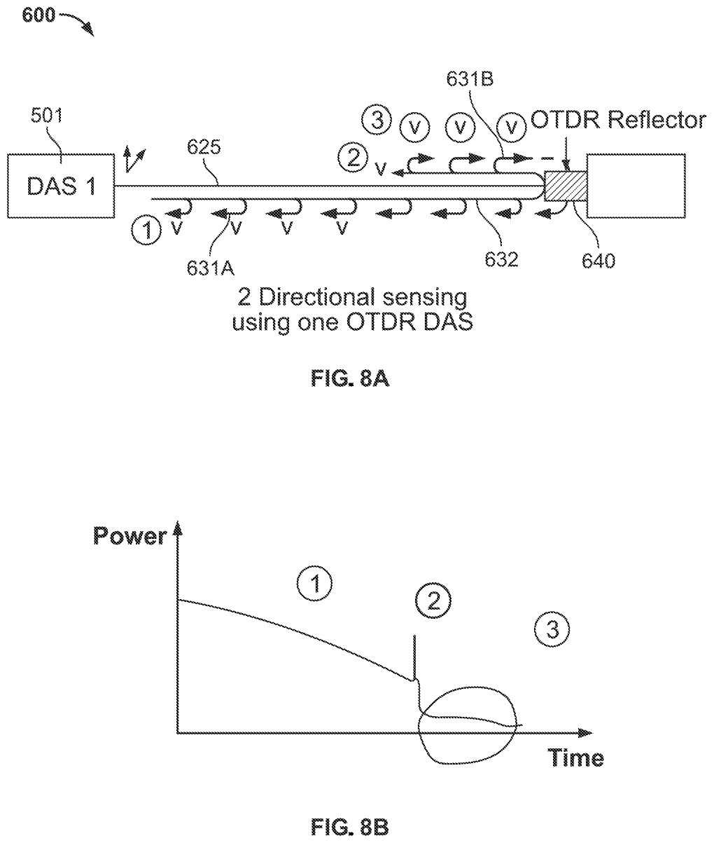

Referring now to FIG. 8A, fiber optic system 600 is the same as or substantially similar to fiber optic system 500 except that, most notably, fiber optic system 600 includes only a single optical fiber characterization unit 501, which may be a DAS unit, and an optical reflecting element 640, e.g., a mirror, in place of a second DAS unit. However, alternative arrangements of fiber optic system 600 may use a second optical fiber characterization unit, e.g., a second DAS unit, in conjunction with optical reflecting element 640. In such alternative arrangements, optical reflecting element 640 may be moveable to allow optical pulses emitted from optical fiber characterization unit 501 to reach the second optical fiber characterization unit.

In the example of fiber optic system 600 shown, DAS unit 501 receives backscattered light portions and communicates data associated with the backscattered light portions 631A to central control unit 520 (not shown in FIG. 8A) as described above with respect to the modified arrangement using fiber optic system 500. Optical pulse remaining portions 632 of the optical pulse emitted from DAS unit 501 travel along optical fiber 625 and are reflected by optical reflecting element 640, as shown. The reflection of optical pulse remaining portions 632 creates subsequent backscattered light portions 631B that are reflected back to optical reflecting element 640 and then back to the optical receiving device of DAS unit 501.

With reference to FIGS. 8A and 8B, backscattered light portions 631A, the reflections of optical pulse remaining portions 632, and subsequent backscattered light portions 631B are received by the optical receiving device of DAS unit 501 during different time intervals designated as 1, 2, and 3 in the plot of FIG. 8B. As shown in FIG. 8B, a spike in optical power level occurs when optical pulse remaining portions 632 reflected from optical reflecting element 640 are received by DAS unit 501.

Similarly to the configuration of fiber optic system 500, when backscattered light portions 631A or subsequent backscattered light portions 631B interface with a compressed or at least translated inner region of optical fiber 625, e.g., one formed by an external disturbance, a spike in optical power level is registered by central control unit 520. A clock device associated with DAS unit 501 measures the time for backscattered light portions 631A, the reflections of optical pulse remaining portions 632, and subsequent backscattered light portions 631B to be received by the optical receiving device of DAS unit 501 after the emission of their respective optical pulse from the DAS unit. Using power level data associated with the measured times for the various received light portions and with a preset value corresponding to a length of optical fiber 625, central control unit 520 or remote office 750 in communication with the optical receiving device of DAS unit 501 is able to ascertain an approximate location of an external disturbance as described above with respect to fiber optic system 500 based on optical fiber locations associated with spikes seen in optical power levels of backscattered light portions 631A and subsequent backscattered light portions 631B. As some of both backscattered light portions 631 A and subsequent backscattered light portions 631B are caused by an interface with the compressed or at least translated inner region of optical fiber 625 but from different directions, multiple spikes in power level may be identified by central control unit 520 or remote office 750 in communication with the optical receiving device of DAS unit 501 at different times but correspond to a same location of a disturbance. In this manner, single DAS unit 501 can be used as a bi-directional sensing unit as the DAS unit obtains data based on light traveling in opposite directions.

Again referring to FIG. 9, optical fiber network 700 includes a plurality of DAS units 701 attached to multiple other DAS units 701 by optical fibers 725. The DAS units may be synchronized using any of the processes for synchronization discussed previously herein such that the DAS units may provide external disturbance location data from various disturbances across a large region when lengths of optical fibers 725 are known or are otherwise determined as described previously herein. The various disturbances may be from sounds or other vibrations from construction sites 795, vehicles 796, or other disturbances sufficient to compress or at least translate optical fibers 725. DAS units 701 may be in communication, e.g, via cloud network 745, with remote office 750, as shown. Remote office 750 may have maps of all optical fiber locations to display information for identifying locations of disturbances sufficiently heard or otherwise felt by optical fibers 725.

It is to be further understood that the disclosure set forth herein includes any possible combinations of the particular features set forth above, whether specifically disclosed herein or not. For example, where a particular feature is disclosed in the context of a particular aspect, arrangement, configuration, or embodiment, that feature can also be used, to the extent possible, in combination with and/or in the context of other particular aspects, arrangements, configurations, and embodiments of the technology, and in the technology generally.

Furthermore, although the technology herein has been described with reference to particular features, it is to be understood that these features are merely illustrative of the principles and applications of the present technology. It is therefore to be understood that numerous modifications, including changes in the sizes of the various features described herein, may be made to the illustrative embodiments and that other arrangements may be devised without departing from the spirit and scope of the present technology. In this regard, the present technology encompasses numerous additional features in addition to those specific features set forth in the paragraphs below. Moreover, the foregoing disclosure should be taken by way of illustration rather than by way of limitation as the present technology is defined by the paragraphs set forth below.

1. An optical fiber apparatus characterization system, comprising:
a first optical fiber apparatus;
a first clock device;
a first optical transmission device at a first end of the first optical fiber apparatus, in electrical or wireless communication with the first clock device, and configured to emit first optical pulses along the first optical fiber apparatus;
a first optical receiving device proximal to the first optical transmission device, in electrical or wireless communication with the first clock device, and configured to receive first backscattered or reflected optical pulse remaining portions of the first optical pulses emitted by the first optical transmission device, the first backscattered or reflected optical pulse remaining portions being respectively backscattered or reflected by and along the first optical fiber apparatus towards the first optical receiving device;
a second clock device;
a second optical receiving device at a second end of the first optical fiber apparatus opposite the first end, in electrical or wireless communication with the second clock device, and configured to receive first optical pulse portions of the first optical pulses emitted along the first optical fiber apparatus; and
a first electronic control unit in communication with the first clock device, the first optical transmission device, the first optical receiving device, the second clock device, and the second optical receiving device,
wherein the first clock device and the second clock device are synchronized or have respective times offset by a known offset value such that the first electronic control unit determines a first characteristic of the first optical fiber apparatus or of the first optical pulses based on, or using optical data derived from the first optical pulses and associated with, a time that one of the first optical pulses is emitted from the first optical transmission device and a time that a corresponding one of the first optical pulse portions is received by the second optical receiving device.

2. The optical fiber apparatus characterization system of claim 1, wherein the first electronic control unit determines a second characteristic of the first optical fiber apparatus or of the first optical pulses based on, or using optical data derived from the first optical pulses and associated with, a time that one of the first optical pulses is emitted from the first optical transmission device and a time that a corresponding one of the first backscattered or reflected optical pulse remaining portions of the first optical pulses emitted by the first optical transmission device and reflected along the first optical fiber apparatus towards the first optical receiving device is received by the first optical receiving device.

3. The optical fiber apparatus characterization system of claim 1, wherein the first optical fiber apparatus has a sufficient length such that ones of the first backscattered or reflected optical pulse remaining portions of the first optical pulses backscattered or reflected by the second end of the first optical fiber apparatus are not received by the first optical receiving device.

4. The optical fiber apparatus characterization system of claim 1, further comprising a second optical transmission device configured to emit second optical pulses along the first optical fiber apparatus, wherein the second optical receiving device is proximal to the second optical transmission device and configured to receive second backscattered or reflected optical pulse remaining portions of the second optical pulses emitted by the second optical transmission device and respectively backscattered or reflected along the first optical fiber apparatus towards the first optical receiving device.

5. The optical fiber apparatus characterization system of claim 4, wherein the first optical receiving device is configured to receive second optical pulse portions of the second optical pulses emitted along the first optical fiber apparatus, and wherein the first optical fiber apparatus has a sufficient length such that ones of the second backscattered or reflected optical pulse remaining portions of the second optical pulses backscattered or reflected by the first end of the first optical fiber apparatus are not received by the second optical receiving device.

6. The optical fiber apparatus characterization system of claim 5,
wherein the first electronic control unit determines a second characteristic of the first optical fiber apparatus or of the first optical pulses based on, or using optical data derived from the first optical pulses, a time that one of the first optical pulses is emitted from the first optical transmission device and a time that a corresponding one of the first backscattered or reflected optical pulse remaining portions of the first optical pulses emitted by the first optical transmission device along the first optical fiber apparatus is received by the first optical receiving device, and
wherein the first electronic control unit determines a third characteristic of the first optical fiber apparatus or of the second optical pulses based on, or using optical data derived from the second optical pulses, a time that one of the second optical pulses is emitted from the second optical transmission device and a time that a corresponding one of the second backscattered or reflected optical pulse remaining portions of the second optical pulses emitted by the second optical transmission device along the first optical fiber apparatus is received by the second optical receiving device.

7. The optical fiber apparatus characterization system of claim 4, wherein the first backscattered or reflected optical pulse remaining portions of the first optical pulses received by the first optical receiving device and the second backscattered or reflected optical pulse remaining portions of the second optical pulses received by the second optical receiving device do not travel over a same region of the first optical fiber apparatus, and wherein the first characteristic determined by the first electronic control unit corresponds to a portion of the first optical fiber apparatus from which neither one of the first backscattered or reflected optical pulse remaining portions of the first optical pulses and the second backscattered or reflected optical pulse remaining portions of the second optical pulses is backscattered or reflected by the first optical fiber apparatus.

8. The optical fiber apparatus characterization system of claim 4, wherein the first backscattered or reflected optical pulse remaining portions of the first optical pulses received by the first optical receiving device and the second backscattered or reflected optical pulse remaining portions of the second optical pulses received by the second optical receiving device travel over a shared region of the first optical fiber apparatus, and wherein the first characteristic determined by the first electronic control unit corresponds to a portion of the first optical fiber apparatus at which both the first backscattered or reflected optical pulse remaining portions of the first optical pulses and the second backscattered or reflected optical pulse remaining portions of the second optical pulses are backscattered or reflected by the first optical fiber apparatus.

9. The optical fiber apparatus characterization system of claim 1, wherein the first characteristic is a length of the first optical fiber apparatus, and wherein the length is determined in a length determining process by the first electronic control unit based on a product of a time of travel of the corresponding one of the first optical pulse portions received by the second optical receiving device from the first optical transmission device and a preset speed of the first optical pulses, the time of travel being determined based on a difference between a second clock time of the second clock device at the time the corresponding one of the first optical pulse portions is received by the second optical receiving device and a corresponding first clock time of the first clock device at the time the corresponding one of the first optical pulses is emitted from the first optical transmission device.

10. The optical fiber apparatus characterization system of claim 9, wherein the first electronic control unit periodically or continuously monitors the length of the first optical fiber apparatus using the length determining process.

11. The optical fiber apparatus characterization system of claim 1, further comprising:
a second optical fiber apparatus; and
a second optical transmission device at a first end of the second optical fiber apparatus, in electrical or wireless communication with the second clock device, and configured to emit second optical pulses along the second optical fiber apparatus,
wherein the second optical receiving device and the second optical transmission device are part of a second optical termination assembly.

12. The optical fiber apparatus characterization system of claim 11, further comprising an optical switch, wherein the second optical transmission device is further configured to emit the second optical pulses along the first optical fiber apparatus via the optical switch, and wherein the second optical receiving device is configured to receive second backscattered or reflected optical pulse remaining portions of the second optical pulses emitted along the first optical fiber apparatus and to receive second backscattered or reflected optical pulse remaining portions of the second optical pulses emitted along the second optical fiber apparatus.

13. The optical fiber apparatus characterization system of claim 11, wherein the first electronic control unit determines a second characteristic of the second optical fiber apparatus or of the second optical pulses emitted by the second optical transmission device along the second optical fiber apparatus based on, or using optical data derived from the second optical pulses emitted by the second optical transmission device along the second optical fiber apparatus and associated with, a time that one of the second optical pulses is emitted from the second optical transmission device along the second optical fiber apparatus and a time that a corresponding one of second backscattered or reflected optical pulse remaining portions of the second optical pulses is received by the second optical receiving device.

14. The optical fiber apparatus characterization system of claim 11, further comprising a third optical receiving device proximal to the second optical transmission device, in electrical or wireless communication with the second clock device, and configured to receive second backscattered or reflected optical pulse remaining portions of the second optical pulses emitted by the second optical transmission device, the second backscattered or reflected optical pulse remaining portions being respectively backscattered or reflected by and along the second optical fiber apparatus towards the third optical receiving device,
wherein the third optical receiving device is part of the second optical termination assembly.

15. The optical fiber apparatus characterization system of claim 14, further comprising:
a third clock device;
a fourth optical receiving device at a second end of the second optical fiber apparatus opposite the first end, in electrical or wireless communication with the third clock device, and configured to receive second optical pulse portions of the second optical pulses emitted along the second optical fiber apparatus,
wherein the first electronic control unit is in communication with the second optical transmission device, the third clock device, and the fourth optical receiving device,
wherein the second optical fiber apparatus has a sufficient length such that ones of the second backscattered or reflected optical pulse remaining portions of the second optical pulses backscattered or reflected by the first end of the second optical fiber apparatus are not received by the fourth optical receiving device, and
wherein the second clock device and the third clock device are synchronized or have respective times offset by a known offset value such that the first electronic control unit determines a first characteristic of the second optical fiber apparatus or of the second optical pulses based on, or using optical data derived from the second optical pulses and associated with, a time that one of the second optical pulses is emitted from the second optical transmission device and a time that a corresponding one of the second optical pulse portions is received by the fourth optical receiving device, and
wherein the first electronic control unit determines a second characteristic of the second optical fiber apparatus or of the second optical pulses based on, or using optical data derived from the second optical pulses and associated with, a time that one of the second optical pulses is emitted from the second optical transmission device and a time that a corresponding one of the second backscattered or reflected optical pulse remaining portions of the second optical pulses is received by the third optical receiving device.

16. The optical fiber apparatus characterization system of claim 11, further comprising:
a third clock device;
a fourth optical receiving device at a second end of the second optical fiber apparatus opposite the first end, in electrical or wireless communication with the third clock device, and configured to receive second optical pulse portions of the second optical pulses emitted along the second optical fiber apparatus,
wherein the first electronic control unit is in communication with the second optical transmission device, the third clock device, and the fourth optical receiving device,
wherein the second optical fiber apparatus has a sufficient length such that ones of second backscattered or reflected optical pulse remaining portions of the second optical pulses backscattered or reflected by the first end of the second optical fiber apparatus are not received by the fourth optical receiving device, and
wherein the second clock device and the third clock device are synchronized or have respective times offset by a known offset value such that the first electronic control unit determines a first characteristic of the second optical fiber apparatus or of the second optical pulses based on, or using optical data derived from the second optical pulses and associated with, a time that one of the second optical pulses is emitted from the second optical transmission device and a time that a corresponding one of the second optical pulse portions is received by the fourth optical receiving device.

17. The optical fiber apparatus characterization system of claim 11, further comprising:
an additional optical fiber apparatus; and
an additional optical transmission device at a first end of the additional optical fiber apparatus and configured to emit first additional optical pulses along the additional optical fiber apparatus,
wherein the first optical transmission device and the first optical receiving device are part of a first optical termination assembly,
wherein the additional optical transmission device is part of a third optical termination assembly, and
wherein at least two optical fibers extend from each of the termination assemblies such that an optical fiber extends between every pair of termination assemblies in the optical fiber apparatus characterization system.

18. The optical fiber apparatus characterization system of claim 17, further comprising an additional optical receiving device in electrical or wireless communication with the first clock device and configured to receive additional optical pulse portions of the additional optical pulses, wherein the additional optical receiving device is at a second end of the additional optical fiber apparatus opposite the first end of the additional optical fiber apparatus and is part of the first optical termination assembly.

19. The optical fiber apparatus characterization system of claim 1, further comprising:
an optical reflecting element configured to reflect at least parts of the first optical pulse portions of the first optical pulses along the first optical fiber apparatus such that the reflected parts of the first optical pulse portions are received by the first optical receiving device along the first optical fiber apparatus via the first optical fiber apparatus, the first and the second clock devices being asynchronous during a first time period from when the first optical pulse is emitted from the first optical transmission device along the first optical fiber apparatus to when the reflected parts of the first optical pulse portions are received by the first optical receiving device along the first optical fiber apparatus,
wherein the first electronic control unit instructs a clock adjustment to be made, the clock adjustment including a first adjustment of a first clock time of the first clock device, a second adjustment of a second clock time of the second clock device, or a combination of adjustments of both the first and the second clock times such that the first and the second clock devices are synchronized with each other.

20. The optical fiber apparatus characterization system of claim 19, wherein the optical reflecting element is a mirror.

21. The optical fiber apparatus characterization system of claim 1, further comprising:
an optical reflecting element configured to reflect the first reflected optical pulse remaining portions of the first optical pulses along the first optical fiber apparatus such that the first reflected optical pulse remaining portions of the first optical pulses are received by the first optical receiving device via the first optical fiber apparatus,
wherein the first and the second clock devices are asynchronous during a first time period from when an initial first optical pulse of the first optical pulses is emitted from the first optical transmission device to when an initial first reflected optical pulse remaining portion of the first reflected optical pulse remaining portions is received by the first optical receiving device, and
wherein the first electronic control unit is configured for instructing a clock adjustment to be made, the clock adjustment including a first adjustment of a first clock time of the first clock device, a second adjustment of a second clock time of the second clock device, or a combination of adjustments of both the first and the second clock times such that the first and the second clock devices are synchronized with each other.

22. The optical fiber apparatus characterization system of claim 21, wherein the clock adjustment is only the second adjustment, and wherein the second adjustment is a value equal to half of the sum of the first clock time when the initial first reflected optical pulse remaining portion is received by the first optical receiving device and the first clock time when the initial first optical pulse is emitted by the first optical transmission device less the second clock time when an initial first optical pulse portion of the initial first optical pulse is received by the second optical receiving device.

23. The optical fiber apparatus characterization system of claim 21, wherein the first optical transmission device and the first optical receiving device are parts of a first transceiver.

24. The optical fiber apparatus characterization system of claim 21, wherein the second optical receiving device is part of a second transceiver.

25. The optical fiber apparatus characterization system of claim 21, wherein, when the first and the second clock devices are synchronized, a length of the first optical fiber is determined, in a length determining process, by the first electronic control unit based on a product of a time of travel of a second optical pulse portion of a second optical pulse from the first optical transmission device to the second optical receiving device and a preset speed of the second optical pulse, the time of travel of the second optical pulse portion being determined based on a difference between the second clock time at the time the second optical pulse portion is received by the second optical receiving device and the first clock time at the time the second optical pulse is emitted from the first optical transmission device.

26. The optical fiber apparatus characterization system of claim 25, wherein the first electronic control unit periodically or continuously monitors the length of the first optical fiber apparatus using the length determining process.

27. The optical fiber apparatus characterization system of claim 25, further comprising a second electronic control unit in electrical or wireless communication with the second clock device and the second optical receiving device, wherein the second optical receiving device is configured to receive the second optical pulse portion, and wherein, the second electronic unit is configured such that when the first and the second clock devices are synchronized, the second electronic control unit samples both initial optical power level data from the second optical pulse at the time the second optical pulse is emitted from the first optical transmission device and subsequent optical power level data from the second optical pulse portion at the time the second optical pulse portion is received by the second optical receiving device and, in a distortion determining process, determines one or more differences between the initial and the subsequent optical power level data in order to ascertain optical distortion characteristics associated with the first optical fiber.

28. The optical fiber apparatus characterization system of claim 21, wherein the first optical transmission device and the first optical receiving device are part of an optical time domain reflectometer or a distributed acoustic sensing unit.

29. The optical fiber apparatus characterization system of claim 21, wherein the first electronic control unit is remote from each of the first clock device, the first optical transmission device, the first optical receiving device, the second clock device, and the second optical receiving device.

30. The optical fiber apparatus characterization system of claim 21, further comprising a second electronic control unit in electrical or wireless communication with the second clock device and the second optical receiving device, wherein the first electronic control unit is proximal to the first transmission device and the second electronic control unit is proximal to the second optical receiving device, and wherein the second electronic control unit is in electrical or wireless communication with the first clock device, the first optical transmission device, and the first optical receiving device via the first electronic control unit.

31. The optical fiber apparatus characterization system of claim 21, wherein the optical reflecting element is a mirror.

32. The optical fiber apparatus characterization system of claim 31, wherein the mirror is positioned and otherwise configured relative to the second optical receiving device such that the mirror separates the first reflected optical pulse remaining portion received by the first optical receiving device from the first optical pulse while allowing the first optical pulse portion to pass by the mirror and thereby be received by the second optical receiving device.

33. The optical fiber apparatus characterization system of claim 1, further comprising:
a second optical transmission device at a second end of the first optical fiber apparatus opposite the first end, in electrical or wireless communication with the first clock device, and configured to emit second optical pulses along the first optical fiber apparatus,
wherein the first optical receiving device is configured to receive second optical pulse portions of the second optical pulses along the first optical fiber apparatus,
wherein the second optical receiving device is proximal to the second optical transmission device,
wherein the first electronic control unit is further in communication with the second optical transmission device,
wherein the first and the second clock devices are asynchronous during a first time period from when an initial first optical pulse of the first optical pulses is emitted from the first optical transmission device to when an initial second optical pulse portion of an initial second pulse of the second optical pulses is received by the first optical receiving device, an initial first optical pulse portion of an initial first optical pulse of the first optical pulses being received by the second optical receiving device and the initial second optical pulse being transmitted by the second optical transmission device prior to the initial second optical pulse portion being received by the first optical receiving device, and
wherein the first electronic control unit is configured for instructing a clock adjustment to be made, the clock adjustment including a first adjustment of a first clock time of the first clock device, a second adjustment of a second clock time of the second clock device, or a combination of adjustments of both the first and the second clock times such that the first and the second clock devices are synchronized with each other.

34. The optical fiber apparatus characterization system of claim 33, wherein the clock adjustment is only the second adjustment, and wherein the second adjustment is a value equal to half of the sum of the absolute value of the difference between the second clock time when the initial first optical pulse portion is received by the second optical receiving device and the first clock time when the initial first optical pulse is emitted by the first optical transmission device and the absolute value of the difference between the first clock time when the initial second optical pulse portion is received by the first optical receiving device and the second clock time when the initial second optical pulse is emitted by the second optical transmission device.

35. (canceled)

36. The optical fiber apparatus characterization system of claim 1, further comprising:
a second optical transmission device at a second end of the first optical fiber apparatus opposite the first end and configured to emit second optical pulses along the first optical fiber apparatus;
wherein the first optical receiving device is configured to receive second optical pulse remaining portions of the second optical pulses emitted by the second optical transmission device along the first optical fiber apparatus and towards the first optical receiving device, and configured to receive second backscattered or reflected light portions reflected by the first optical fiber apparatus and thereby towards the first optical receiving device from the second optical pulse remaining portions,
wherein the second optical receiving device is proximal to the second optical transmission device and configured to receive first backscattered or reflected light portions reflected by the first optical fiber apparatus and thereby towards the second optical receiving device from the first optical pulse remaining portions,
wherein the first electronic control unit is further in communication with the second optical transmission device, and
wherein the first electronic control unit is configured to determine a location along the first optical fiber apparatus corresponding to a location of a first disturbance external to the first optical fiber apparatus based on a deviation from a first threshold value of a first signal associated with the first backscattered or reflected light portions received by the first electronic control unit and a deviation from a second threshold value of a second signal associated with the second backscattered or reflected light portions received by the first electronic control unit.

37. The optical fiber apparatus characterization system of claim 36, wherein the deviation from the first threshold value of the first signal corresponds to a reduction in a first power level of the first backscattered or reflected light portions as determined by the first electronic control unit and the deviation from the second threshold value of the second signal corresponds to a reduction in a second power level of the second backscattered or reflected light portions.

38. The optical fiber apparatus characterization system of claim 36, wherein the deviation from the first threshold value of the first signal corresponds to a change of frequency of the first signal as determined by the first electronic control unit and the deviation from the second threshold value of the second signal corresponds to a change of frequency of the second signal as determined by the first electronic control unit.

39. The optical fiber apparatus characterization system of claim 36, wherein at least a portion of the first optical fiber apparatus is translated by the first disturbance.

40. The optical fiber apparatus characterization system of claim 39, wherein the portion of the first optical fiber apparatus includes an outer region of the first optical fiber apparatus, and wherein the outer region is at least partially compressed by the first disturbance.

41. The optical fiber apparatus characterization system of claim 36,
wherein the first electronic control unit includes a first preset value corresponding to a determined length of the first optical fiber apparatus, and
wherein the first electronic control unit is configured to determine the location along the first optical fiber apparatus corresponding to the location of the first disturbance based on a first location value computed using the first preset value and first timing data from the second clock device corresponding to a time of travel of the first backscattered or reflected light portions associated with the deviation from the first threshold value of the first signal and a second location value computed using a second preset value and second timing data from the first clock device corresponding to a time of travel of the second backscattered or reflected light portions associated with a deviation from the second threshold value of the second signal.

42. The optical fiber apparatus characterization system of claim 36, wherein the first threshold value and the second threshold value are the same value.

43. The optical fiber apparatus characterization system of claim 36,
wherein the first optical receiving device is further configured to receive third backscattered or reflected light portions of the first optical pulses emitted by the first optical transmission device along the first optical fiber apparatus and towards the second optical receiving device,
wherein the second optical receiving device is further configured to receive fourth backscattered or reflected light portions of the second optical pulses emitted by the second optical transmission device along the first optical fiber apparatus and towards the first optical receiving device, and
wherein the first electronic control unit is further configured to determine the location along the first optical fiber apparatus corresponding to the location of the first disturbance external to the first optical fiber apparatus based on a deviation from a third threshold value of a third signal associated with the third backscattered or reflected light portions received by the first electronic control unit from the first optical receiving device and a deviation from a fourth threshold value of a fourth signal associated with the fourth backscattered or reflected light portions received by the first electronic control unit from the second optical receiving device.

44. The optical fiber apparatus characterization system of claim 36, wherein the first optical transmission device and the first optical receiving device are part of a first distributed acoustic sensing unit and the second optical transmission device and the second optical receiving device are part of a second distributed acoustic sensing unit.

45. The optical fiber apparatus characterization system of claim 36, wherein the first signal is received by the first electronic control unit from the second optical receiving device and the second signal is received by the first electronic control unit from the first optical receiving device.

46. An optical network, comprising:
the optical fiber apparatus characterization system of claim 36; and
at least one additional optical fiber apparatus characterization system, the at least one additional optical fiber apparatus characterization system being in electrical or optical communication with the optical fiber apparatus characterization system.

47-55. (canceled)
